(19) United States
(12) Patent Application Publication
(10) Pub. No.: US 2024/0184435 A1
(43) Pub. Date: Jun. 6, 2024

(54) OPERATIONS PLAYBACK

(71) Applicant: Zimeno Inc., Livermore, CA (US)

(72) Inventor: Sadasivudu MALLADI, San Jose, CA (US)

(73) Assignee: Zimeno Inc., Livermore, CA (US)

(21) Appl. No.: 18/525,725

(22) Filed: Nov. 30, 2023

Related U.S. Application Data
(60) Provisional application No. 63/534,154, filed on Aug. 23, 2023.
(60) Provisional application No. 63/429,174, filed on Dec. 1, 2022.

(51) Int. Cl. G06F 3/04842; G06F 3/0481; G06T 11/00; G07C 5/06

(52) U.S. Cl. CPC G06F 3/04842; G06F 3/0481; G06T 11/00; G07C 5/06; G06T 2200/24

(57) ABSTRACT

An operations playback system may record and store operations data during movement of a vehicle, associate different locations with different operations data values, output control signals causing a display to present an image of a region traversed by the vehicle, receive a selection of a portion of the image being presented from a graphical user interface, determine a particular location based on the selection of the portion of the image, and output control signals causing the display to present a displayed operations data value that is based upon a particular operations data value associated with the particular location.

### CROSS-REFERENCE TO RELATED APPLICATIONS

The present non-provisional application claims priority from co-pending U.S. provisional patent Application Ser. No. 63/429,174 filed on Dec. 1, 2022, by Sadasivudu Malladi and entitled OPERATIONS PLAYBACK, and co-pending U.S. provisional patent Application Ser. No. 63/534,154 filed on Aug. 23, 2023, by Gatten et al. and entitled VEHICLE CONTROL, the full disclosures of which are hereby incorporated by reference.

### BACKGROUND

Vehicles, ground and airborne, come in a variety of forms such as tractors, semi-trailers, cement mixers, trucks, harvesters, sprayers, construction vehicles, drones, planes, helicopters and the like. Such vehicles may have a variety of operational parameters and may conduct a variety of different operations. Managing and analyzing their operations is sometimes challenging, but may offer opportunities for enhanced automation, land, vineyard, crop or orchard management, vehicle maintenance, operator assignment, vehicle design, and vehicle use.

### BRIEF DESCRIPTION OF THE DRAWINGS

FIG. 1 is a diagram schematically illustrating portions of an example operations playback system.

FIG. 2 is a flow diagram of an example operations playback method.

FIG. 3 is a diagram schematically illustrating portions of an example vehicle and implement/attachment that may be used as part of an example operations playback system.

FIG. 4 is a diagram of the example operations playback system of FIG. 1 operating in a different mode.

FIG. 5 is a flow diagram of an example operations playback method.

FIG. 6 is a flow diagram of an example operations playback method.

FIG. 7 is a diagram schematically illustrating a display with an example region map and associated operations data values.

FIG. 8A is a screenshot from an example display of an example operations playback system presenting example inputs for selecting a particular operations playback or record for a particular vehicle or group of vehicles for a particular provide operators and for a particular time.

FIG. 8B is a screenshot from an example display of the example operations playback system presenting a selected operations playback depicting an example map with example operations of a selected vehicle and associated operation data values.

FIG. 8C is a screenshot of an example display of the example operations playback system presenting an enlargement of the selected operations playback of FIG. 8B.

FIG. 8D is a screenshot from the example display of 8C further illustrating an example menu for selecting one or more map layers.

FIG. 8E is a screenshot from the example display of FIG. 8C further illustrating an example map layer in the form of guard rails.

FIG. 8F is a screenshot from the example display of FIG. 8C further illustrating an example map layer in the form of error codes.

FIG. 8G is a screenshot from the example display of FIG. 8C further illustrating an example map layer in the form of tickets.

FIG. 9 is a perspective view illustrating portions of an example vehicle, in the form of an example tractor, and portions of an example implement/attachment, provided as part of operations playback system.

FIG. 10 is a diagram illustrating a display depicting an example stored routine comprising an example stored path of the vehicle with stored operation data values associated with geographic coordinates along the path.

FIG. 11 is a diagram illustrating the display of FIG. 10 during a modification of the example routine of FIG. 11.

FIG. 12 is a diagram illustrating the display depicting the modified example stored routine of FIG. 10.

FIG. 13 is a diagram of an example display depicting a series of plant rows for the creation of a stored routine.

FIG. 14 is a diagram of a first display depicting an example stored routine and a second display depicting the series of plant rows of FIG. 13 during the addition of portions of the stored routine of the first display to the series of plant rows to create a second stored routine.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example operations playback systems, vehicle operation data recording and retrieval systems, and methods that facilitate retrieval and analysis of operations data pertaining to a vehicle and/or its implement/attachments. The example systems and methods provide an intuitive approach for viewing different operational states and operational data of the vehicle and/or implement/attachments as the vehicle traverses a field, vineyard, orchard or other geographic region. As a result, an operator or manager may be better able to evaluate and troubleshoot operations of the vehicle and operations performed on different regions traversed by the vehicle.

Disclosed are example operations playback systems, vehicle operation data recording and retrieval systems and methods that facilitate the storage or recording of operations data pertaining to a vehicle and/or its implement/attachments and the association or linking of geographical coordinates to the stored operations data values. The example systems and methods systems and methods further facilitate subsequent use of the stored operation data values and associated geographical coordinates as a geography-based program or routine, wherein the same or similar operations data values are achieved by the vehicle and/or its implement when the vehicle and such or implement subsequently traverses the same geographical coordinates. Said another way, the vehicle and/or its implements may effectively playback the prior operations based upon the vehicle traveling to particular geographic coordinates. For example, the recorded program or routine may comprise a first operations data value (such as a first vehicle speed) for a first range of geographic coordinates, a second operations data value (such as a second different vehicle speed) for a second range of geographic coordinates immediately following the first time range, a third operations data value (such as a third difference vehicle speed) for a third range of geographic coordinates immediately following the second time range, and so on. An operator may enter a command or instruction causing this routine to be conducted at any subsequent time, wherein the controller whopper control signals such that the vehicle exhibits the same pattern of speeds and time ranges.

In some implementations, a series of stored operational data values and their respective times or durations are recorded, wherein the stored values and duration/times form a time-based routine or program based upon time rather than geographic location and wherein a controller outputs control signals such that the time-based routine or program may be repeated at a later time. For example, the recorded program or routine may comprise a first operations data value (such as a first vehicle speed) for a first time range, a second operations data value (such as a second different vehicle speed) for a second time range immediately following the first time range, a third operations data value (such as a third difference vehicle speed) for a third time range immediately following the second time range, and so on. An operator may enter a command or instruction causing this routine to be conducted at any subsequent time, wherein the controller outputs control signals such that the vehicle exhibits the same pattern of speeds and time ranges.

In some implementations, a series of stored operational data values and their respective distances traveled by the vehicle are recorded, wherein the stored values and travel distances form a travel distance routine or program based upon distance traveled by the vehicle rather than geographic location or elapsed time and wherein a controller outputs control signals such that the travel distance based routine or program may be repeated at a later time. For example, the recorded program or routine may comprise a first operations data value (such as a first vehicle speed) for a first travel distance by the vehicle (and implement), a second operations data value (such as a second different vehicle speed) for a second travel distance immediately following the first travel distance, a third operations data value (such as a third different vehicle speed) for a third travel distance immediately following the second travel distance, and so on. An operator may enter a command or instruction causing this routine to be conducted at any subsequent time, wherein the controller outputs control signals such that the vehicle exhibits the same pattern of operation data values (speeds) and travel distances. After the vehicle has traveled the first travel distance, the controller outputs control signals causing the vehicle to achieve the second operations data value. After the vehicle has traveled the second travel distance, following the first travel distance, the controller outputs control signals causing the vehicle to achieve the third operations data value, and so on.

In some implementations, the example operations playback systems, vehicle operation data recording and retrieval systems, and methods facilitate modifying the stored program or routine by selecting particular portions of a displayed map or image. In such implementations, the controller may output control signals causing the display to present an image of a region traversed by the vehicle. The controller may further receive a selection of a portion of the image being presented from the graphical user interface. Based upon the selection of the portion of the image, the controller may determine the geographic coordinates of a particular location corresponding to the selected portion of the image. The controller may output control signals causing the display to present a displayed operations data value that is based upon a particular the particular location. Thereafter, the controller may receive and store a modification for at least one operations data value associated with the particular location and output control signals causing the vehicle to operate so as to achieve the modified operations data value when the vehicle is subsequently at the particular location.

In some implementations, the controller is configured to receive a second selection of a second portion of the image being presented from the graphical user interface. The controller may then record a new operations data value for a third portion of the image based upon the second selection of the second portion of the image. The controller may output control signals causing the vehicle to operate so as to achieve the new operations data value when the vehicle is subsequently at a location corresponding to the third portion of the image.

For purposes of this disclosure, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, unless otherwise explicitly set forth, the recitation of a “processor”, “processing unit” and “processing resource” in the specification, independent claims or dependent claims shall mean at least one processor or at least one processing unit. The at least one processor or processing unit may comprise multiple individual processors or processing units at a single location or distributed across multiple locations.

For purposes of this disclosure, the phrase “configured to” denotes an actual state of configuration that fundamentally ties the stated function/use to the physical characteristics of the feature proceeding the phrase “configured to”.

For purposes of this disclosure, the term “releasably” or “removably” with respect to an attachment or coupling of two structures means that the two structures may be repeatedly connected and disconnected to and from one another without material damage to either of the two structures or their functioning.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

For purposes of this, unless explicitly recited to the contrary, recitations reciting that signals “indicate” a value or state means that such signals either directly indicate a value, measurement or state, or indirectly indicate a value, measurement or state. Signals that indirectly indicate a value, measure or state may serve as an input to an algorithm or calculation applied by a processing unit to output the value, measurement or state. In some circumstances, signals may indirectly indicate a value, measurement or state, wherein such signals, when serving as input along with other signals to an algorithm or calculation applied by the processing unit may result in the output or determination by the processing unit of the value, measurement or state.

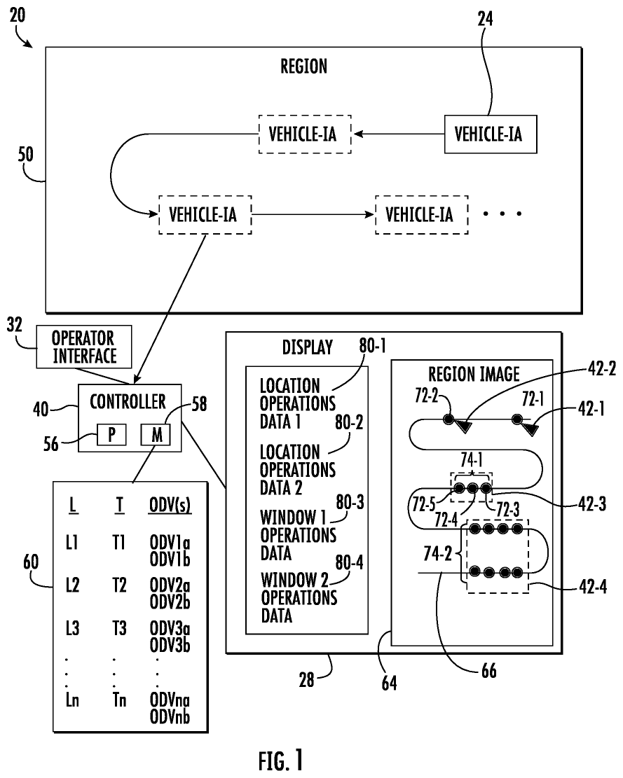

FIG. 1 is a diagram schematically illustrating at least portions of an example operations playback system 20. System 20 comprises vehicle 24, display 28, operator interface 32 and controller 40. Vehicle 24 (schematically illustrated) may comprise a self-propelled vehicle such as a tractor, harvester, truck, semi-trailer, sprayer, a passenger vehicle, drone, airplane, or other vehicle, whether a ground-based vehicle or an airborne vehicle. Vehicle 24 is configured to traverse or travel across a region 50 which may be in the form of a field, a vineyard, orchard or the like.

Vehicle 24 may include or carry implement or attachments that further interact with region 50. Such implements/attachments may comprise cultivators, sprayers, fertilizer/insecticide applicators, pruning devices, blades or cutting devices, buckets, forks, sprayer booms, and the like. Vehicle 24 may include various sensors that output signals indicating operational data values or from which operational data values may be derived. Examples of such sensors include potentiometers, global positioning satellite (GPS) systems, inertial measurement units, accelerometers, gyroscopes, wheel encoders, cameras, infrared sensors, ultraviolet sensors, light detection and ranging (LIDAR) sensors, battery or voltage sensors and the like.

Display 28 comprises a device configured to output a visual presentation in response to or based upon signals from controller 40. Display 28 may be in the form of a touchscreen, a display monitor, a smart phone screen, a laptop or desktop screen or the like. Display 28 may be carried by vehicle 24 or may be remote from vehicle 24. Display 28 may be stationary or fixed, or may be portable, being configured to be manually carried by a person.

Operator interface 32 comprise a device by which an operator, locally residing on vehicle 24 or remote from vehicle 24, may interact with controller 40. Operator interface 32 is configured to facilitate the input of data, selections or commands by an operator. Operator interface 32 may comprise a keyboard, mouse, microphone, touchpad, joystick or other component by which a graphical user interface (GUI) 42-1, 42-2, 42-3 and/or 42-4 (collectively referred to as graphical user interfaces 42) may be presented are moved on display 28. As shown by FIG. 1, graphical user interfaces 42 may have any one of a variety of different forms, such as cursors or pointers (GUIs 42-1, 42-2) or Windows (GUIs 42-3, 42-4) which may be controllably sized or zoomed.

Controller 40 directs the presentation of graphics and information on display 28. Controller 40 receives operational data from vehicle 24. Controller 40 may poll or may receive transmission of data signals from various sensors associated with vehicle 24 and/or its implement/attachments. Controller 40 may poll or receive transmission of data signals from a controller on vehicle 24 which controls the operations of vehicle 24 and/or its attachments/implements. Controller 40 comprises processing unit 56 and memory 58.

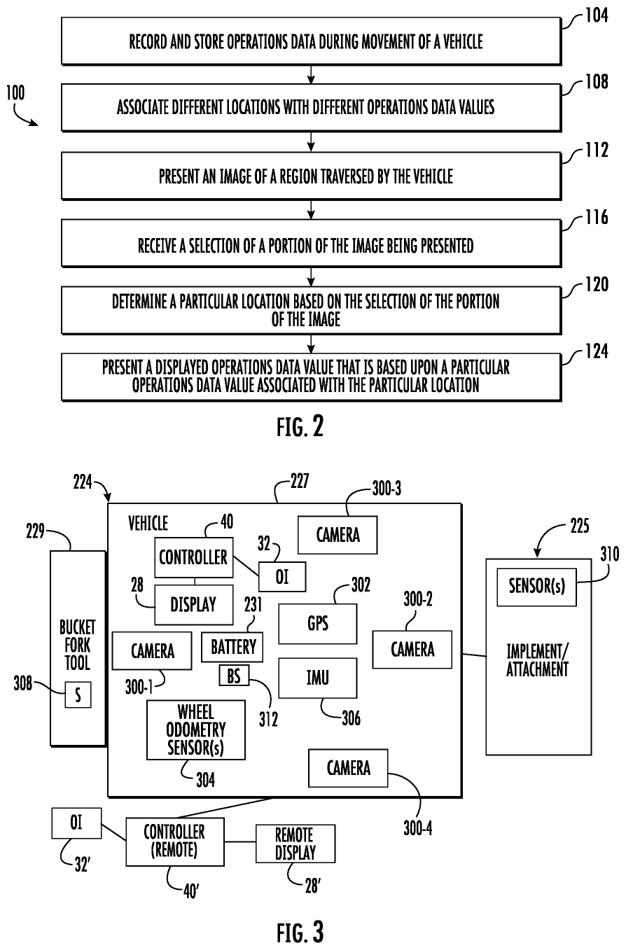

Processing unit 56 carries out instructions provided in memory 58. Processing unit 56 may conduct analysis and may output control signals based upon the instructions in memory 58. Memory 58 comprises a non-transitory computer-readable medium which stores such instructions. The instructions in memory 58 are part of a vehicle operations data recording and retrieval system. Instructions in memory 58 may direct processing unit 56 to conduct the example operations playback method 100 shown in FIG. 2.

As indicated by block 104 in FIG. 2, instructions in memory 58 direct processing unit 56 to record and store operations data during movement of vehicle 24 within the geographic region 50 (shown in FIG. 1). In some implementations, the operations data is obtained and stored in a continuous fashion as the vehicle moves within the geographic region 50. In some implementations, the operations data is obtained and stored in a periodic fashion, at predefined or user selected time intervals. In some implementations, the operations data is obtained and stored at predefined, or user selected distance increments traveled by the vehicle 24. For example, the operation data may be obtained stored every 3 feet of travel by the vehicle 24. In some implementations, the operation data is obtained and stored in response to a command as entered by an operator using operator interface 32.

In some implementations, the operations data may be obtained and stored any time at which the value of the operations data being monitored or sensed changes in an amount above a predefined threshold. Use of the threshold amount may reduce unwanted data recordings that are simply changing due to electrical or sensing noise. In those implementations where operant data is recorded in response to a change in a value of the operations data, controller 40 may automatically repeat storage of the most recent operation data value until the change, until the operation data has a new value exceeding the threshold. For example, at a first location, the value for a particular type of operations data may change, resulting in storage of the value X. At a second location or type of operation data may once again change, resulting in storage of a new value Y. For all those locations traversed by the vehicle second locations and for all the times during which the vehicle is traveling between the first second locations, the controller 40 may automatically record the value X.

In some implementations, different types of operations data may be obtained and stored based upon different factors or at different frequencies. For example, controller 40 may obtain and store values for first type of operation data based upon a first predetermined or user selected periodic time interval, a first vehicle travel distance increment, or in response to a value change above a first predefined or user selected threshold. Controller 40 may likewise obtain and store values for a second different type of operations data at different times than the storage of the values for the first type of operation data. Controller 40 may obtain and store values for the second different type of operation data based upon a second predetermined or user selected periodic time interval, a second vehicle travel distance increment, or in response to a value change above a second predefined or user selected threshold (a recording threshold), wherein the second periodic time interval, the second vehicle travel distance increment and the second threshold are different than the first periodic time interval, the first vehicle travel distance increment and/or the first value change, respectively.

In some implementations, controller 40 may obtain and store operations data at different frequencies or at different times based upon the location of vehicle 24. For example, controller 40 may obtain and store operations data at a first frequency when traveling within a first area of region 50 and may obtain different frequency when traveling within a second different area of region 50. Different areas of region 50 may be associated with different periodic time intervals, different vehicle travel distance increments and/or different recording thresholds. Different types of operation data may have different periodic time intervals, different vehicle travel distance increments and such or different recording thresholds in different areas of region 50. For example, the remaining battery charge may have a first periodic time interval in a first region and a second different periodic time interval in a second region.

In some implementations, the frequency or rate at which operations data is obtained and stored may vary depending upon the value of the operations data itself. For example, remaining battery charge may be obtained and stored at a first rate when the remaining battery charge is above a predefined or user selected threshold and may be obtained and stored at a second or frequent rate when the remaining battery charge is below the predefined or user selected threshold. Upon the remaining battery charge following below the predefined threshold, the frequency at which remaining battery charge “readings” or obtained may be increased by controller 40. Different types of operations data may have different thresholds that trigger changes to the rate at which operations data is collected and stored.

In some implementations, the rate, timing or frequency at which operations data is collected and stored by controller 40 may vary based upon the type of operation being carried out by vehicle 24 and/or its implement/attachment. For example, values for remaining battery charge may be obtained and stored at a first rate during a first type of operation being carried out by vehicle 24 and may be obtained and stored at a second different rate during a second type of operation being carried out by vehicle 24 and/or its implement/attachment. In some implementations, the rate, timing or frequency at which values for a first type of operations data are obtained and stored by controller 40 may vary based upon the values be obtained and stored for other types of operations data. In other words, the rate, timing or frequency at which values for a first type of operation that are obtained may vary based upon the values currently being obtained and stored by controller 40 for a second different type of operations data.

The operations data may comprise data directly received from the controls or sensors of vehicle 24 and/or its implement/attachment (vehicle-IA) or may be derived by controller 40 (processing unit 56 following instructions contained in memory 58) from signals from one or more sensors of vehicle 24 and/or its implement/attachment. Examples of operations data include, but are not limited to, vehicle speed; vehicle mode (manual/autonomy), vehicle health, human detection, path obstructions, snapshots, videos, ticket creation, remaining battery charge, battery voltage, remaining fuel level (in vehicles powered by fuel), oil levels, oil temperatures, battery temperature, battery swap state, vehicle RPM, implement height, implement status, bucket height, bucket orientation, bucket load, wheel slip, vehicle path, vehicle pitch, vehicle roll, vehicle diagnostics such as fuse outages, component hydraulic pressures, hydraulic fluid, such as transmission pressure, accumulator pressure, brake pressure, hydraulic fluid temperatures, radiator or coolant temperatures, light and/or display working status, login status, power takeoff RPM and the like.

The operations data may pertain to a condition or state of the implement/attachment, including any materials or resources currently carried by the implement/attachment. Examples of such operations data may include, but are not limited to, current or remaining material (liquid or dry, herbicide, insecticide, fertilizer) volume and/or weight, application/distribution rate, applications/distribution spread, plant interaction members (mower blades or the like) speed, height or angle, ground interaction members (wheels, tracks, discs, blades and the like) position, angle, experienced force) and/or the roll, pitch, yaw or height of the implement/attachment.

As indicated by block 108 in FIG. 2, controller 40 associates different locations with different operations data values (ODVs). As shown by FIG. 1, in some implementations, controller 40 may store a lookup in memory 58 or in another memory. The table 60 may include a listing of a plurality of different locations L1-Ln across which vehicle 24 traversed when traveling in region 50. For each of locations L1-Ln, lookup table 60 may also list one or more operational data values (ODV1a, ODV1b . . . ODVnb). Each of the individual data values are associated with a corresponding to a particular individual location L in region 50. In the example illustrated, two different operations data values are associated with each individual location. For example, a speed of vehicle 24 and a battery charge level of vehicle 24 may both be associated with each individual different location L1-Ln. Although table 60 depicts two different types of operation data being associated with each location, in other implementations, controller 40 may associate a single type of operational data or greater than two different types of operational data which each recorded location L.

In the example illustrated, controller 40 is configured to operate in two operator selectable modes pertaining to the locations L1-Ln and the associated data values. In a first mode, the locations L are geographic locations or geographic coordinates. Such geographic coordinates may be obtained from a GPS system carried by vehicle 24 and/or its implement/attachment or may be determined by controller 40 based upon a map, and initial starting point for vehicle 24 and vehicle odometry (the use of cameras, wheel encoders alike to determine direction and distance of travel of vehicle 24). In a second mode, the locations L are positions of vehicle 24 relative to a known or predetermined starting location for vehicle 24. For example, a first position may be 50 yards along a row, wherein a second position may be 100 yards from the starting point along the row. In some implementations, controller 40 may provide only one of the two example modes for the locations of vehicle 24.

As further shown by FIG. 1, in some implementations, controller 40 additionally associates a time T with each particular location L. In some implementations, the time T may be a chronological time as acquired from a clock. In some implementations, the time T may be an amount of time, such as an amount of time elapsed since a startup of vehicle 24 or since vehicle 24 began traveling in region 50 or along a particular role of region 50. In some implementations, the amount of time may be an amount of time remaining prior to the ending of travel of vehicle 24. In the example illustrated, controller 40 associates times T1-Tn with locations L1-Ln are also associated with the various operations data values ODVs.

As indicated by block 112 in FIG. 2, controller 40 presents an image of region 50 which has been traversed by vehicle 24. An example image 64 of a portion of the region 50 is presented on display 28 in FIG. 1. In the example illustrated, the image may additionally include or depict the path 66 traversed by the vehicle 24. In some implementations, path 66 may be omitted.

As indicated by block 116 in FIG. 2, controller 40 receives a selection of a portion of the image being presented. The selection may be provided from an operator using operator interface 32. The selection may be input by a keyboard or touchscreen. The selection may be in the form of positioning of a graphical user interface (one of interfaces 42) presented on image 64 and moved or manipulated using a joystick, mouse or the like.

The example region image 64 illustrated in FIG. 1 illustrates graphical user interfaces 42-1 and 42-2 in the form of cursors which point to portions in the form of particular locations 72-1 and 72-2, respectively, along or near the path 66 that was traversed by vehicle 24 in region 50. Each particular location has at least one associated time value and at least one associated operations data value. In some implementations, each particular location may correspond to a particular individual pixel or a corresponding individual cluster or group of pixels of a larger array of pixels forming the image 64.

The example map or region image 64 illustrated in FIG. 1 further illustrates graphical user interfaces 42-3 and 42-4 in the form of windows which encompass or surround sets 74-1 and 74-2, respectively, of multiple particular locations along or near the path 66 that was traversed by vehicle 24 in region 50. As discussed above, each of the particular locations surrounded by the window of GUI 42-3 or GUI 42-4 may constitute an individual pixel or a cluster group of pixels of a larger array of pixels forming image 64. In circumstances where a window GUI surrounds multiple particular locations, the window GUI may be associated with a plurality of operations data values for each type of data value. For example, the example window GUI 42-3 is illustrated as surrounding three particular locations. In the example where the operations data associated with each particular location comprise vehicle speed and remaining battery charge, the portion of image 64 and of region 50 defined by window GUI 42-3 would be associated with three values for vehicle speed and three values for remaining battery charge. Such values may or may not be the same. In some implementations, the size and location of the window GUIs 42-3, 42-4 may be controllably varied. For example, the size of the particular window GUI may be made longer, made taller, may be increased in size or may be reduced in size through manipulation of a mouse, joystick or other device. In some implementations, a scrollbar may be used to shrink or enlarge, zoom in or zoom out a particular window GUI so as to control what particular locations are surrounded by the window GUI and the number of particular locations surrounded by the window GUI.

As indicated by block 120 of FIG. 2, controller 40 determines a particular location based upon the selection of the portion of the image 64. For example, each of the pixels (or group/cluster of pixels) forming image 64 may correspond to a particular location in the actual region 50. Based upon this relationship, controller 40 may determine that pixel x,y is being pointed to by the cursor of GUI 42-1. Controller 40 may further determine that pixel x,y corresponds to the particular location 72-1. Controller 40 may determine that the range of pixels x₁,y₁-pixels xₙ,yₙ are surrounded by window GUI 42-3. Controller 40 may further determine that the range of pixels x₁,y₁-pixels xₙ-yₙ includes pixels that correspond to particular locations 72-3, 72-4 and 72-5 in the actual region 50.

As indicated by block 124 of FIG. 2, controller 40 outputs control signals causing display 28 to present a displayed operations data value 80-1, 80-2, 80-3, 80-4, that is based upon a particular operations data value associated with the particular location. In the example illustrated in FIG. 1, controller 40 causes display 28 to present the displayed operations data values 80-1 which comprise the operational data values previously associated with the particular location 72-1 which correspond to the pixels or group of pixels in image 64 being selected by the positioning of the cursor GUI 42-1. Controller 40 causes display 28 to present the displayed operations data values 80-2 which comprise the operational data values previously associated with the particular location 72-2 which correspond to the pixels or group of pixels in image 64 being selected by the positioning of the cursor GUI 42-2.

Controller 40 causes display 28 to present the displayed operations data values 80-3 which are based upon a combination of the operational data values previously associated with the particular locations 72-3, 72-4 and 72-5 which correspond to the pixels or group of pixels in image 64 being selected by the positioning of the window cursor GUI 42-3. In some implementations, the displayed operations data values may be averages of the individual operation data values for the particular sets of particular locations. For example, in implementations where the operation data values associated with each location comprise vehicle speed and remaining battery charge, the displayed operations data values 80-3 may comprise an average of the vehicle speeds when the vehicle was at the particular locations 72-3, 72-4 and 72-5. The displayed operations data values 80-3 may comprise an average of the remaining battery charge of vehicle 24 when vehicle 24 was at the particular locations 72-3, 72-4 and 72-5. In other implementations, other statistical combinations (lowest value, highest value, median, mode or the like) may be presented as the displayed operational data value for the particular locations surrounded by the window GUI.

As with respect to displayed operations data value 80-3, Controller 40 causes display 28 to present the displayed operations data values 80-4 which are based upon a combination of the operational data values previously associated with the particular locations (represented by darkened dots) which correspond to the pixels or group of pixels in image 64 being selected by the positioning of the window cursor GUI 42-4.

In short, controller 40 identifies what portions of image 64 or what pixels of image 64 are being selected by the graphical user interface. Controller 40 then determines what locations in the actual region depicted by the image correspond to the selected portions, pixels or group of pixels. Controller 40 then consults a lookup table 60 or other memory to identify what operational data values are associated with the particular locations that correspond to the selected pixels or group of pixels. Lastly, controller 40 presents the displayed operation data values which may be the operation data values themselves or values that are determined by controller 40 based upon a combination of multiple operation data values associated with multiple locations. As result, an operator or manager may quickly identify operations data for vehicle 24 and/or its implement attachment at any particular location or multiple particular locations in the region 50 traversed by vehicle 24.

In the example illustrated, image 64 and the displayed location operations data 80 are simultaneously or concurrently presented on display 28. In other implementations, the displayed operations data 80 may be presented on display 28 at a time different than the display of image 64. In some implementations, the displayed operations data may be presented on top of image 64, adjacent to the corresponding selected portion of image 64.

In some implementations, rather than the operational data being directly associated with region locations, wherein the region locations are associated with individual pixels in the image of the region, the operational data may be indirectly associated with region locations via the pixels or group of pixels forming the image. The operational data may be directly associated with the different pixels or groups of pixels of image 64, wherein the displayed operational data may be directly retrieved or derived based upon what pixels or group of pixels are selected by the graphical user interface 42.

FIG. 3 is a diagram schematically illustrating portions of an example vehicle 224 with an example implement/attachment 225. Vehicle 224 and implement/attachment 225 may be utilized as the vehicle 24 and implement/attachment in system 20 described above. FIG. 3 further illustrates variations for an example operations data recording and retrieval system. In the example illustrated, vehicle 224 comprises a chassis 227 hooked up or carrying implement/attachment 225 and further supporting a releasable removable bucket/fork/tool 229. The implement/attachment 225 and the bucket/fork/tool 229 may be in one of various states, such as different heights, orientations and the like. The bucket/fork/tool 229 may be raised and lowered using hydraulics. The implement/attachment 225 may be raised and lowered using hydraulics (a three-point hitch) and may be powered via hydraulic lines, a power takeoff or the like. In some implementations, the bucket/fork/tool 229 and/or implement/attachment may be omitted.

In the example illustrated, vehicle 224 further comprises a battery 231 which provides electrical power for driving a motor to propel vehicle 224. In some implementations, electric motor may power a hydraulic pump which drives a hydraulic motor to further assist in propelling vehicle 224. Power from battery 231 may be utilized to also power the raising and lowering or tilting of bucket/fork/tool 229 and the powering of implement/attachment 225.

Vehicle 224 comprises various operations data acquisition devices in the form of cameras 300-1, 300-2, 300-3, 309-4 (collectively referred to as cameras 300), GPS receiver 302, wheel odometry sensors 304, inertial measurement unit 306, bucket sensors 308, implement/attachment sensors 310 and battery sensors 312. The signals output by such devices indicate (directly or indirectly), or may be used to derive, values for various operations data for vehicle 224 and/or implement/attachment 225. Cameras 300 are located about chassis 227 of vehicle 224 and provide different viewpoints, capturing images or video of the front, rear and opposite sides of vehicle 224. Images from camera 300 may be utilized to derive the travel direction and speed of vehicle 224 for determining a location of vehicle 224. In some implementations, one or more of cameras 300 may be omitted.

GPS receiver 302 receives signals from a global positioning satellite system to train gate the geographic coordinates or geographic location of vehicle 224 as vehicle 224 traversing region 50. Wheel odometry sensors 304 comprise one or sensors carried by vehicle 224 which are configured to output signals indicating the steered direction and speed or distance traveled by vehicle 224. Wheel odometry sensors 304 may comprise wheel encoders, steering angle potentiometers and the like. Signals from wheel odometry sensors 304 in conjunction with signals from GPS receiver 302 or in conjunction with a predetermined or known starting location of vehicle 224 may be utilized to determine particular locations of vehicle 224 as vehicle 224 is traversing region 50 (shown in FIG. 1).

Inertial measurement unit 306 comprises a combination of accelerometers and gyroscopes to determine the yaw, pitch and/or roll of vehicle 224. The pitch and roll of vehicle 224 may change as vehicle 224 is traversing different portions of region 50. Signals from inertial measurement unit 306 may be utilized by controller 40 to determine operations data values corresponding to the pitch and/or roll of vehicle 224 at different particular locations.

Bucket/fork/tool sensors 308 comprises sensor that outputs signals indicating the height and/or tilt/orientation of bucket/fork/tool 308. The height and size or tilt/orientation of the bucket/fork/tool 229 may vary as vehicle 224 traverses region 50. Implement/attachment sensors 310 comprises sensors that output signals indicating the current state of implement/attachment 225. Sensors 310 may output signals indicating the height or orientation of implement/attachment 225. Sensors 310 may additionally or alternatively output signals indicating an operational state of implement/attachment 225, such as whether the implement/attachment is on or off, the amount of seed, herbicide, insecticide, fertilizer remaining, the rate or force at which a material is being spread by implement/attachment 225 or the like. Signals from sensors 308 and 310 indicate operations data values that may be associated with different particular locations of vehicle 24 as it is traversing region 50.

Battery sensor 312 comprises a sensor or multiple sensors configured to detect a status of battery 231. Battery sensor 312 may sense the current remaining charge level of battery 231. Battery sensor 312 may sense a current temperature of battery 231. Battery sensor 312 may sense the current voltage level of battery 231. Such operational data values may vary as vehicle 224 traverses region 50.

As shown by FIG. 3, the controller, operating interface and display forming the operations data recording and retrieval system used with vehicle 224 may either reside on vehicle 224 or may be remote from vehicle 224. When provided on vehicle 224, the operations data recording and retrieval system comprises display 28, operator interface 32 and controller 40 as described above. When provided remote from vehicle 224, the operations data recording and retrieval system comprises display 28′, operator interface 32′, and controller 40′. Controller 40′ may receive location signals and operations data signals from vehicle 224 in a wireless fashion or in a wired fashion, such as when vehicle 224 is docked for charging battery 231.

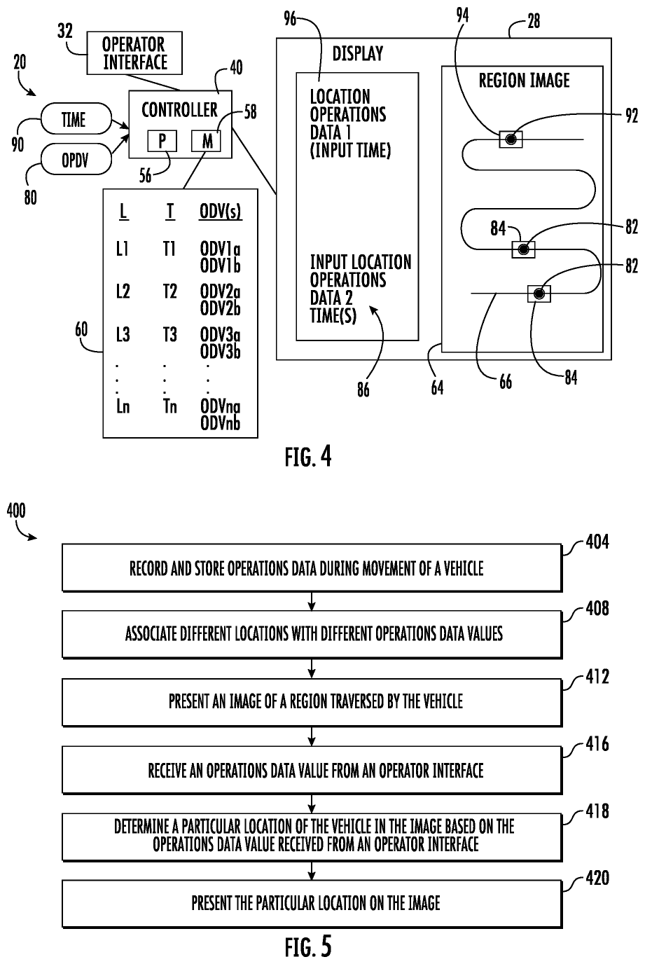

FIG. 4 is a diagram of operations playback system 20 operating in a different user selected mode. In the mode shown in FIG. 4, the operations data values being presented are selected or retrieved based upon timing search value or range or based upon an operations data search value or range of values. The particular location corresponding to the timing value or range or corresponding to the operations data value or range of values is identified and presented as part of image 64. The operational mode shown in FIG. 4 facilitates easy identification of where vehicle 24 was at in region 50 at particular times or the location of vehicle 24 when vehicle 24 and/or its attachments/implement had particular operational states.

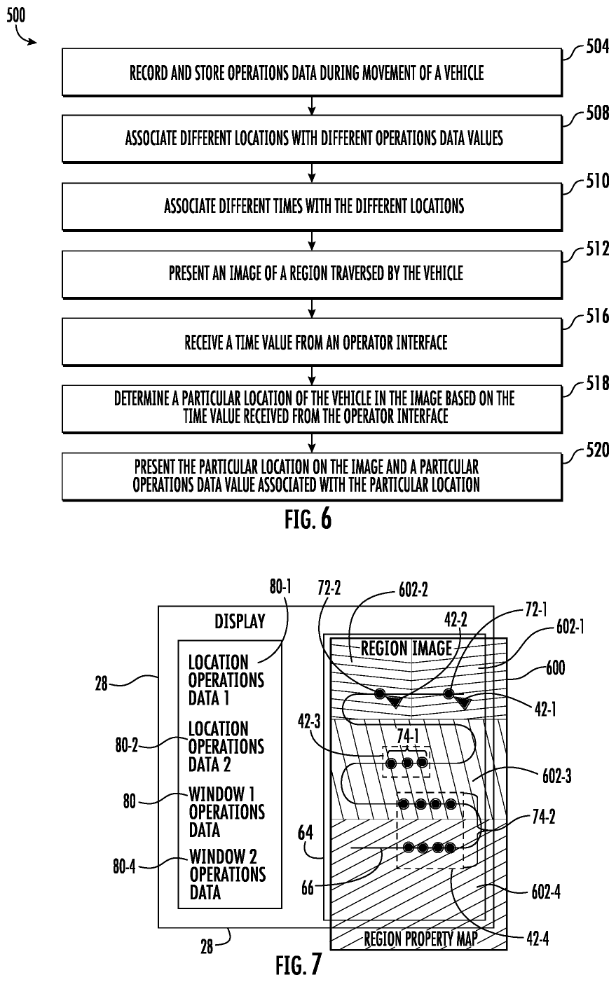

Instructions contained in memory 58 may direct processing unit 56 to carry out the example operations playback method 400 shown in FIG. 5. As indicated by block 404, controller 40 records and stores operations data during movement of vehicle 24 across region 50 (shown in FIG. 1) in a fashion similar to that as described above with respect to block 104 and method 100. As indicated by block 408, light block 108 and method 100, controller 40 associates different locations of vehicle 24 in region 50 with different operations data values. As noted above, such operations data values may be acquired from any of the various operations data acquisition devices associated with vehicle 24 or 224 and/or its implement 225. As indicated by block 412, controller 40 presents an image of the region being traversed by the vehicle on display 28. This described above with respect to block 112 in FIG. 2.

As indicated by block 416 in FIG. 5, controller 40 receives an operations data search value from operator interface 32. The operation data search value may be an individual value, a group of different operation data values or as part of a range of operation data values. The operations data value serves as a search term. As indicated by block 418 in FIG. 5, controller 40 utilizes the input operations data value to identify all of the locations or times of vehicle 24 during which are at which the input operations data value occurred.

As indicated by block 420 in FIG. 5, controller 40 outputs control signals causing display 28 to present the particular location of the vehicle 24 on the map or region image 64 at which the operations data value input in block 416 occurred. In other words, controller 40 depicts vehicle 24 in image 64 each and every time that vehicle 24 and/or its implement/attachment had a recorded operations data value matching the operations data value input by the operator or falling within the operation data value search range entered by the operator. In some implementations, controller 40 may additionally present the time or times at which the vehicle 24 had an associated operations data value that matched our fell within the range of operation data values input by the operator. In implementations where the operator has provided a range of operations data values in block 416, controller 40 may present the exact operations data value of vehicle 24 and/or its implement/attachment that fell within the search range.

In the example shown in FIG. 4, the operator has an input and operations data value range 80 using operator interface 32. In response, controller 40 has identified particular locations 82 as having associated operation data values falling within the range 80. As result, controller 40 outputs control signals causing display 28 to depict representations 84 of vehicle 24 on the region map 64. The operator may visually identify the locations of vehicle 24 when vehicle 24 had operation data values falling within the range 80 on image 64. In the example illustrated, controller 40 further presents the exact operation data values for the particular locations 82 and their associated times (data 86) alongside image 64.

FIG. 6 is a flow diagram illustrating another example mode of operation for controller 40 and operations playback system 20. FIG. 6 illustrates an example operations playback method 500 which may be carried out by controller 40. Blocks 504, 508 and 512 are similar to blocks 404, 408 and 412 of method 400, respectively. As indicated by block 510, controller 40 additionally associates different times with different locations of vehicle 24. Such times may be chronological times or may be an amount of time has elapsed since the beginning of an operations or the amount of time remaining in the recorded operations.

As indicated by block 516, controller 40 receives a time value from an operator via operator interface 32. This time value serves as a search term which is used by controller 40 to identify the location of vehicle 24 at the input time as well as the corresponding associated operation data values. As indicated by block 518, controller 40 determines a particular location of the vehicle in the image based on the time value received from the operator interface. As indicated by block 520, controller 40 presents a particular location of the vehicle 24 on the image and particular operations data value or values associated with the particular location.

In the example shown in FIG. 4, the operator may enter a search time value 90 using operator interface 32. Based upon the input time value, controller 40 determines the location. In the example illustrated, at the input search time, vehicle 24 was at the particular location 92. Accordingly, controller 40 outputs control signals causing display 28 to present a representation 94 of vehicle 24 at the particular location 92 on the region image 64. In addition, controller 40 outputs control signals causing display 28 to present the operation data value or values 96 which have been associated with the particular location 92.

In some implementations, the operator may enter a search range of times using operator interface 32. In such implementations, controller 40 may cause display 28 to present a window enclosing or surrounding all of the different vehicle locations which fall within the range of times. Controller 40 may further cause display 28 to present each of the individual operation data values that occurred within the range of times or may present a composite displayed operations data value which is based upon a combination of the multiple different operation data values that occurred during the range of times. Each type of operations data may have a different composite value for the entered range of times. For example, for a particular range of times, controller 40 may determine and present an average of the remaining battery charge during the particular search window of time. At the same time, controller 40 may determine and present an average speed of vehicle 24 the particular search window of time.

In some implementations, controller 40 may additionally overlay a region property map over the region map, permitting an operator to visually correlate different region properties with different operation data values. For purposes of this disclosure, the term “overlay” may encompass incorporating region property values or indicators directly into image 64 or positioning a partially translucent map or image over top of image 64. Examples of region property maps include, but are not limited to, yield maps, disease/infestation maps, soil type maps, soil moisture maps, topography maps and the like. With an overlaid map, an operator may correlate different operations data values to different resulting crop yields. With an overlaid disease/infestation map, the operator may correlate different operations data values to different crop diseases or insect/fungus infestations. With an overlaid soil type map, an operator may correlate different soil types across the region 50 with different operation data values user experience by vehicle 24 when traversing region 50. With an overlaid soil moisture map, an operator may correlate different levels of soil moisture across region 50 with different operations data values associated with vehicle 24 as it traversed region 50. For example, a first area of region 50 may be low-lying and may be wet whereas a second region 50 may be sandy and dry. Vehicle 24 and/its implement/attachment may vary the operations being performed in the different areas based upon the different levels of moisture in the different areas. With an overlaid topography map, an operator may correlate different elevations or slopes of the terrain being traversed to different operation data values.

FIG. 7 is a diagram schematically illustrating display 28 with region map 64 and operations data value 80-1, 80-2, 80-3 and 80-4 (discussed above 1) but further with an example overlaid region property map 600. Map 600 comprises four different areas 602-1, 602-2, 602-3 and 602-4 identifying distinct areas of region 50 having different properties. As should be appreciated, the size, shape and number of areas provided in the region property map may vary. The different areas may be provided with different shading, different grayscale, different color, different hatching and/or the like to depict or represent different property values. In some implementations, the overlaid map may be in the form of a heat map, reflecting gradations or gradual changes in particular properties across the map 600. As discussed above, such properties may include one or more of: yield, disease/levels, disease/infestation types, soil type, soil moisture, topography, or the like. As shown by FIG. 7, the overlaid region property map 600 may be translucent or at least partially transparent to permit an operator to view the path 66 traversed by the vehicle 24. In some implementations, the operator may toggle between multiple different types of region property maps being overlaid upon region image 64.

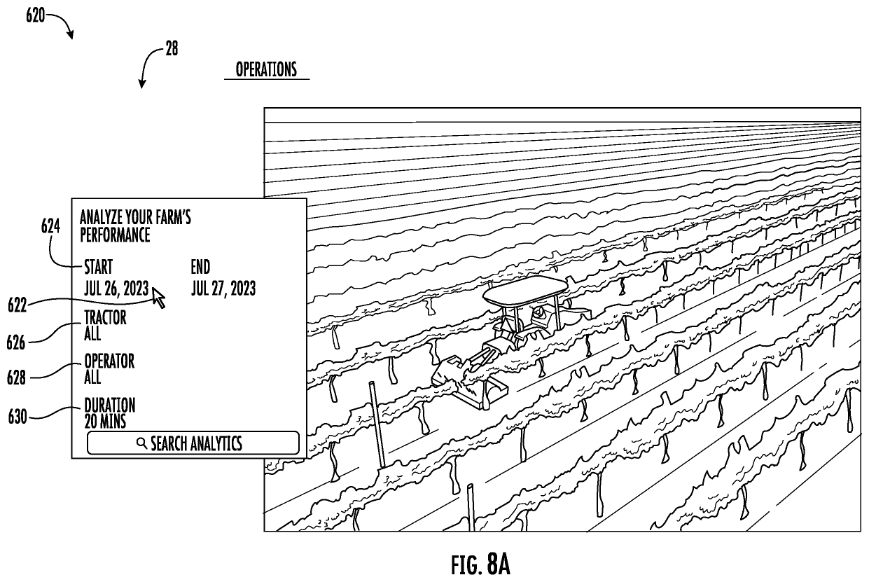

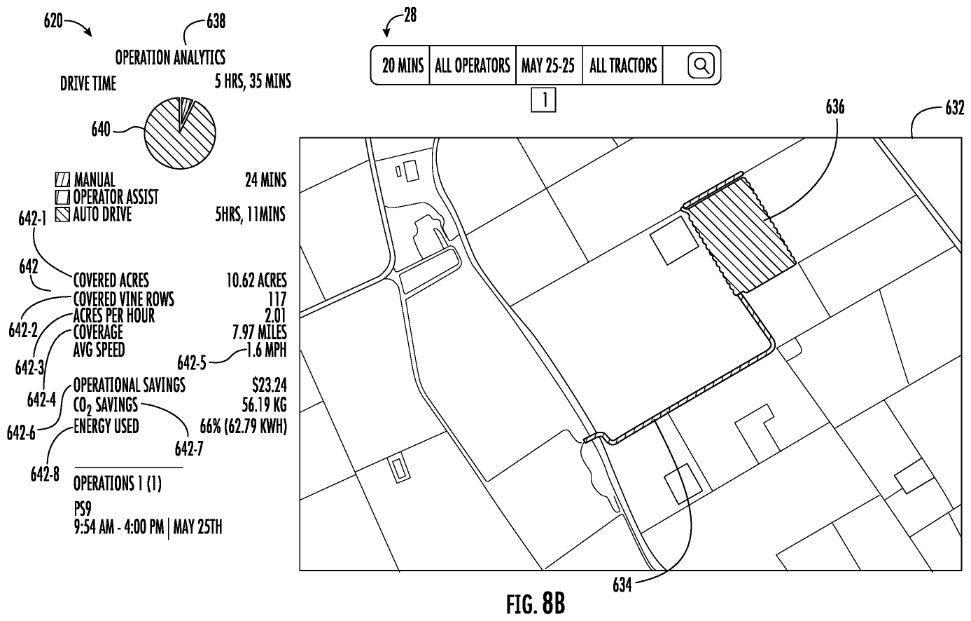

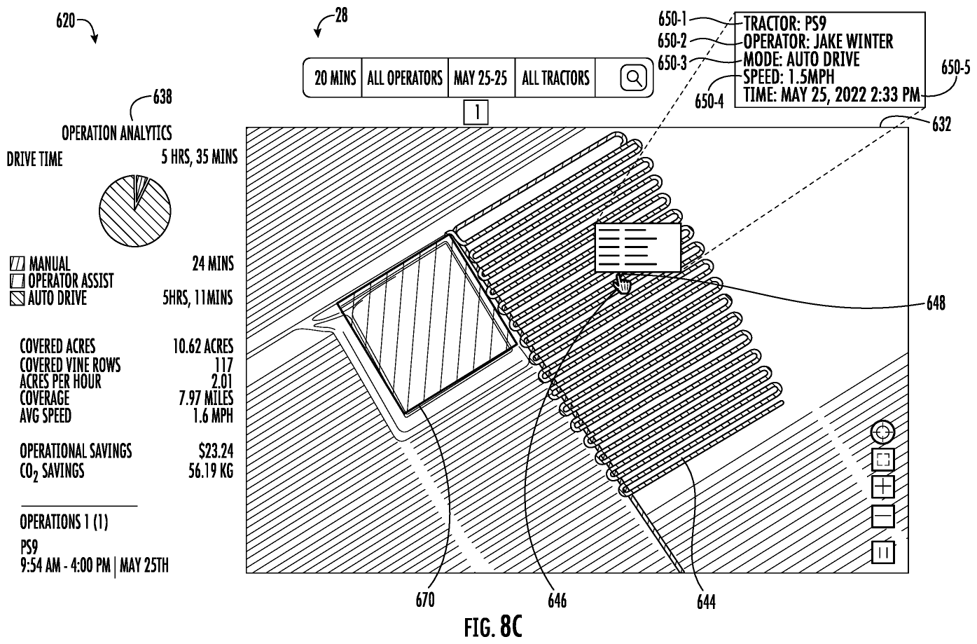

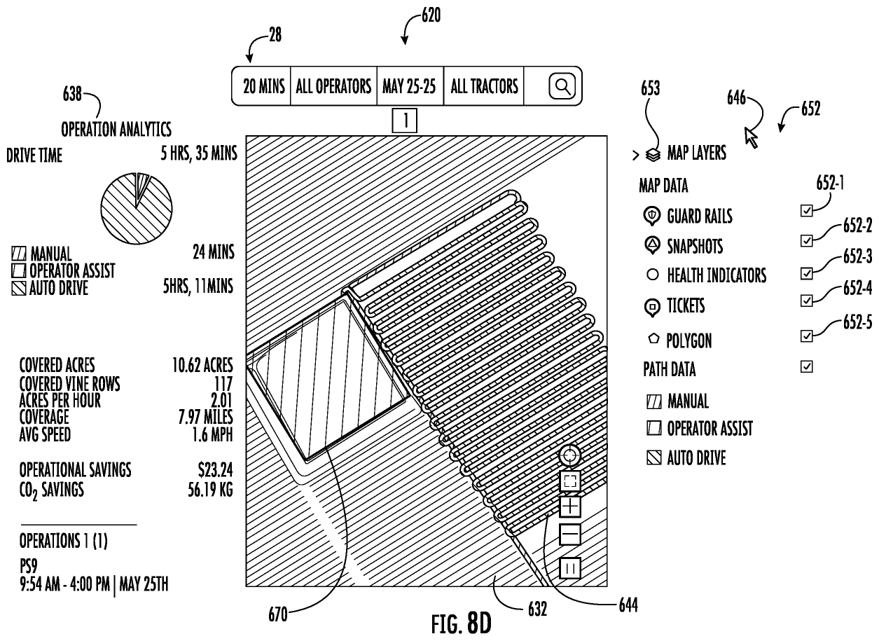

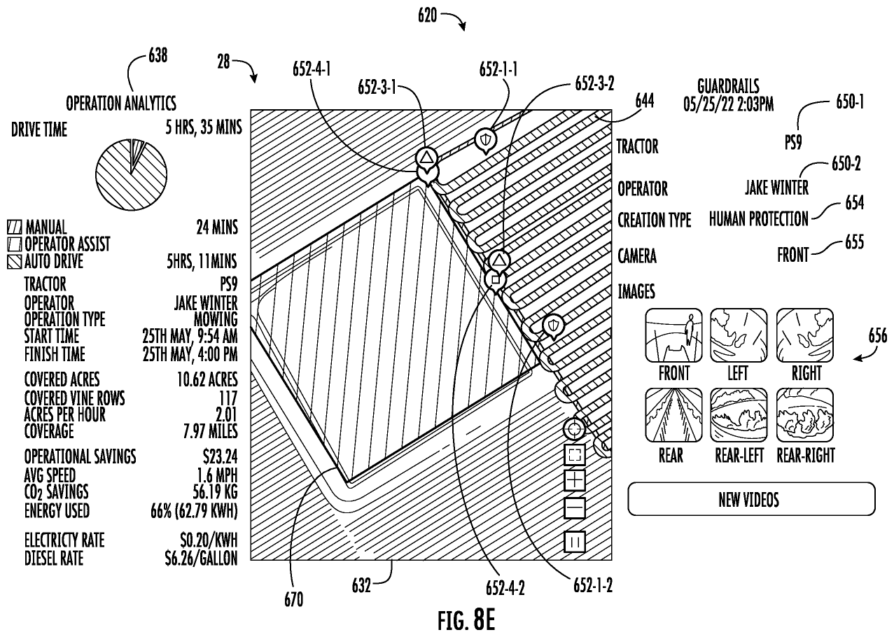

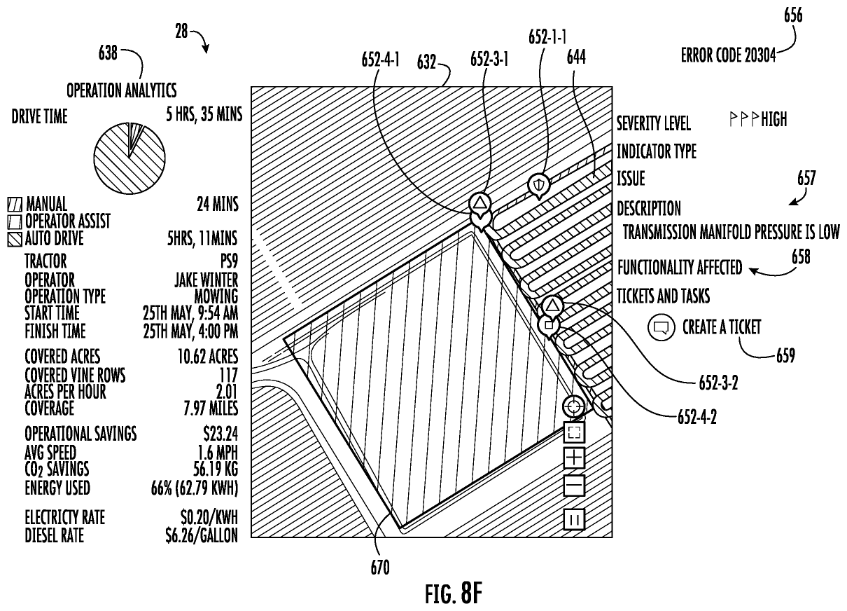

FIGS. 8A-8G illustrate portions of an example operations playback system 620. System 620 comprises display 28, operator interface 32, controller 40, and table 60, each of which is described above with respect to system 20. Controller 40 and table 60 of system 620 may differ from controller 40 and table 60 of system 20 in that the instructions contained in memory 58 and the operational data values in table 60 are configured to additionally or alternatively present the particular example information shown in FIGS. 8A-8G on display 28. In the example illustrated, system 620 may be utilized by vehicle 224 shown in FIG. 3 or the other vehicles having the same, fewer or additional sensors.

As shown in FIG. 8A, a user may manipulate a cursor 622 using operator interface 32 (a mouse, a touchpad or the like) to identify the input of a date or date range to the date range location 624. The date or date range may be further selected using the operator interface 32 (a keyboard or selection of a presented date with a cursor 622). The date range indicate what historical information is to be presented. The day range may be a single day or a range of days.

As further shown by FIG. 8A, manipulation of the cursor 622 may be further utilized to identify for which vehicle or vehicles (of a fleet) the data is to be retrieved (see vehicle input block 626). Manipulation of the cursor 662 may further be utilized to identify for which operator or operators the data is to be retrieved (see operator input block 628). As indicated by duration block 630, the cursor 622 may be manipulated to select a minimum duration threshold for which operational data is recorded. In the example illustrated, only logging sessions of at least 20 minutes results in operational data being recorded. Such a filter preserves storage and bandwidth. In other implementations, the minimum duration threshold may be omitted.

As shown by FIG. 8B, once a date is selected, controller 40 causes display 28 to present a map 632 depicting the geographical area traversed by the one or more vehicles chosen in block 626 while being operated by the operator's chosen area in block 628. The map 632 may depict the path of the vehicle(s) over the geographical area. In the example illustrated, the path is further color-coded (or otherwise coded (line style, line thickness, different graphical symbols and the like) to indicate an operational state of the vehicle(s) during particular portions of the path. In the example illustrated, a first color 634 is utilized to indicate those portions of the path during which the vehicle was in a manual state, steering and speed of the vehicle under complete manual control by an operator. A second color may be utilized to indicate those portions of the path during which the vehicle was in an operator assist mode or state, wherein at least some aspects regarding operation of the vehicle run or automated control and other aspects were under manual control or wherein operation the vehicle was automated, but subject to manual override. Third color 636 may indicate those portions of the path or regions of the map during which the vehicle was in an auto drive state, wherein the steering and speed of the vehicle was automated (without operator intervention).

In the example illustrated, controller 40 further causes display 28 to present an operation analytics presentation 638. In the example illustrated, operation analytics section 638 provides the time during which the vehicle was in each of the manual, operation assist in auto drive motor states in a pie graph 640 picking the portion of total time during which the vehicle is in the particular states. In the example illustrated, the operation analytics section 638 further presents additional statistics 642 for the displayed path of the vehicle(s). The example statistics or operational data values include covered acres 642-1, covered rows 642-2, covered acres per hour 642-3, area coverage and miles 642-4, average speed 642-5, operational savings 642-6, CO₂ savings 642-7 and energy used 642-8. The operational data values may be acquired by controller 40 from various sensors of the vehicle (such as those senses shown and described above with respect to FIG. 3).

In the example illustrated, the vehicle or vehicles are electrically powered vehicles. The operational savings and CO₂ savings data values may be determined by controller 40 based upon an input or chosen cost of electrical power versus the cost of fuel, sensed electrical power consumption of the vehicle(s), and fuel efficiency or consumption (diesel fuel efficiency or consumption) of a corresponding internal combustion engine powered vehicle for the sensed vehicle coverage.

As shown by FIG. 8C, an operator or manager may zoom in on a particular region of the map 632. For example, the operator or manager may move a cursor in a particular direction to initiate a zoom or may manipulate a scroll wheel on a mouse to manipulate a zoom. Zooming in on a particular region causes controller 40 to present a magnified view of the selected region of map 632. In the example illustrated, this magnification results in a display of the serpentine path 644 of the vehicle which was recorded based upon GPS signals or the like.

As further shown by FIG. 8C, the operator or manager may the serpentine path 644 to acquire additional operational data and information at particular points along the serpentine path 644. In the example illustrated, the operator or manager may manipulate a cursor 6462 identify a particular location or 0.648 along the serpentine path 644. In response, controller 40 may present additional information or operational data for the particular point in a bubble or window presented on or within the bounds of map 632 or at other locations on the display 28. In the example illustrated, controller 40 determines or retrieves and presents operational data for location 648, the operational data comprising (1) an identification or type 650-1 of the vehicle (the identification of the tractor), (2) and identification of the particular operator 650-2 operating the vehicle; (3) the operational mode 650-3 of the vehicle (for example, manual, operator assist, auto drive); (4) the particular speed 650-4 of the vehicle at location 648; and (5), the time six Pfizer-5 at which the vehicle was at the particular location 648.

As shown by FIG. 8D, controller 40 may associate various map layers 652 with the map 632. Each of map layers 652 provides a different set of operational data. In the example illustrated, controller 40 provides an operator manager the ability to select from various map layers comprising: guardrails 652-1, snapshots 652-2, health notification 652-3, tickets 652-4 and polygons 652-5. In the example illustrated, the various map options may be selected by movement of a cursor 646 and depression of a mouse button. Such selections may be made in other fashions in other implementations. In response to the cursor pointing to the map layers icon 653 (through depression of a mouse button), controller 40 presents each of the selected map layers on the map 632 as shown in FIG. 8E.

FIG. 8E illustrates display 28 presented by controller 40 in response to the map layers icon 65 being selected and each of the available map layers having its corresponding box “checked”. Each of the map layers 652-1-652-5 being checked results in controller 40 retrieving from memory 58 particular events for each map layer and their associated geographical locations at which the events took place. For each event, controller 40 presents an event icon on map 632. In the example shown in FIG. 80, all of the various map layers are checked. Controller 40 has presented guard rail icons 652-1-1 and 652-1-2, health notification icons 652-3-1, 652-3-2, and ticket icons 652-4-1 and 652-4-2. Each of such icons corresponds to a particular stored event. For example, when an event occurs, such as an infringement of a guard rail, a health notification or an output ticket, controller 40 stores operations data pertaining to the event, including the time and geographic location at which the events took place.

FIG. 8E further illustrates the selection of the particular guard rail icons 652-1-2 through the positioning of a cursor on the particular icon and its selection (such as with a mouse and mouse button). In response, controller 40 retrieves operational data associated with the particular event corresponding to the particular guard rail icons 652-1-2. In the example illustrated controller 40 displays information associate with the guard rail infringement such as particular vehicle type 650-1, the particular operator 650-2, the type of guard rail infringement 654 and the particular camera 655 that captured the infringement. In the example illustrated, controller 40 further presents all of the snapshots 656 taken by various cameras carried by the vehicle at the time of the guard rail infringement. In the example illustrated, the front camera captured the guard rail infringement in the form of a human being identified within the upcoming path of the vehicle. In the example illustrated, an operator/manager may further click on or select a particular snapshot imaged to view an enlarged presentation of the snapshot image on display 28.

FIG. 8F illustrates particular health indicator icon 652-3-2 being selected by an operator/manager (through positioning of a cursor by a mouse and depression of a mouse button or by other means). In response to the icon 652-3-2 being selected or clicked on, controller 40 presents particular information associated with the health indication (health of the vehicle) such as the particular error code 656, a description 657 for the error or health condition, and identification 658 of what, if any, functionality is affected. Such tickets may be automatically transmitted in a wireless fashion to a central server which tracks and stores such health events or errors in which may, in some implementations, automatically schedule or trigger remedial action to address the health condition.

FIG. 8G illustrates particular ticket icon 652-4-2 being selected by an operator/manager (through positioning of a cursor by a mouse and depression of a mouse button or by other means). In response to the icon 652-4-2 being selected or clicked on, controller 40 presents particular information associated with the ticket. A ticket is a notification that remedial action is required. Not all health indicators a result in an automatic ticket. As shown in 8F, in some implementations, the operator/manager may manually create a ticket for a particular health indication event by selecting the “created ticket” icon 659. In other circumstances, controller 40 may automatically create such a ticket in response to a sensed operational data satisfying one or more predefined criteria.

As shown by FIG. 8G, selection of a particular ticket icon results in additional operational data. Presented such as the ticket number 660, a severity level of the ticket 661, a status of the remedial action to, the particular part or piece of equipment that may need replacement or repair 663, the party currently assigned to carry out the remedial action 664, a description 665 of the event or malfunction that caused issuance of ticket, and any tags 666 that may reflect upon any functionality that may be impacted by the current malfunction. In some implementations, the operator/manager may provide additional comments (through use of a keyboard, microphone or other operator interface) by selecting the comment icon 667. The additional comments may be stored in a file associated with the ticket event or icon for subsequent viewing or retrieval.

Selection of the polygon map layer 652-5 (shown in FIG. 8D) results in the various polygons being presented on map 632. Unchecking the polygon map layers 652-5 results in the polygons no longer appearing in map 632. Such polygons serve as area indicators to identify control or other characteristics of particular regions or areas. Such area indicators may be in the form of the line thickness of the polygon, the border style of the polygon, shading within the polygon, highlighting within or over the polygon, color, textual labels or other markings indicating control or other characteristics of the particular regions or areas bounded by the particular polygon.

For example, the map may comprise a first polygon defining an agricultural region and surrounding a series of parallel lines or bars which identify the geographic coordinates of plant rows or vehicle travel spaces. The map may further comprise a second polygon, at least partially surrounding the first polygon, wherein the second polygon outlines or defines a larger region that has or offers wireless communications capabilities for the vehicle and that may surround additional polygons that also include their respective series of parallel lines or bars (identifying plant rows or vehicle travel spaces). The map may further comprise a third polygon, at least partially containing the second polygon, wherein the third polygon outlines or defines the boundaries of ownership for land.

In some implementations, the area indicators may be applied to polygons so as to identify assignments to particular vehicle fueling or charging stations. For example, the map may include multiple polygons, each polygon (containing plant rows or vehicle travel spaces) being color-coded, shaded, labeled or otherwise marked so as to identify which of a plurality of charging stations are assigned to recharging a refueling the vehicle when operating in the agricultural region defined by the particular polygon. Such area indicators may inform a person operating the vehicle where to recharge or refuel the vehicle or may indicate to an automated controller or control system where the vehicle should be driven for refueling are recharging when turning out operations in a particular agricultural region defined by a particular polygon.

In some implementations, the area indicators may be applied to polygons so as to identify the type of plants growing in a particular agricultural region and/or a particular growth stage or condition of the plants in a particular agricultural region. The area indicators may be applied to polygons to indicate at least one prior completed operation, a currently ongoing operation or an operation scheduled to be performed in an agricultural region of the particular polygon. The polygons may be color-coded, shaded, provided with particular border styles, highlighted, labeled or otherwise marked to indicate such information. Such information may be automatically generated and applied to the map or may be applied in response to information received from an operator via an operator interface. In some implementations, such information may be determined or derived in an automated fashion by machine learning, optical analysis or the like using satellite images, aerial images or images acquired from cameras carried by vehicle.

In some implementations, the area indicators may be applied to polygons so as to identify or designate the level of automation that may be utilized when performing operations on agricultural region defined by the polygon. For example, the first polygon may have a first applied area indicator which indicates that the vehicle must be operated manually (a manual mode) when performing operations in the region. A second polygon may have a second applied area indicator indicating that the vehicle may be operating in one or more of a manual, copycat, follow me or auto drive mode.

In some implementations, the area indicator may be applied to polygons so as to designate a selected type of vehicle control to be performed or utilized on the agricultural region defined by the polygon. For example, a controller/operator may determine that a vehicle performing an operation in the first region defined by a first polygon should be controlled manually. The controller/operator may decide to determine that the vehicle performing an operation in a second region defined by a second polygon should be controlled in an automated fashion (auto drive) the controller are permitted determine or decide that vehicle performing operations in a third region defined by a third polygon should be controlled using a copycat or follow me mode. Each of the different modes may be designated by a different distinct area indicator applied to each polygon. Such designations may assist a manager or automated controller in assigning vehicles and personnel to different agricultural regions for different operations.

In some implementations, the area indicators may indicate limitations or designations for particular types of equipment that may be or are to be used in an agricultural region defined by a particular polygon. For example, a first agricultural region defined by first polygon may have an area indicator which indicates that only vehicles up to a particular weight, wheelbase, horsepower, size, and/or functional capability are to be used in the particular agricultural region. Other area indicators may indicate that only vehicles above a particular weight, wheelbase, horsepower, size and/or functional capability are to be used in a particular agricultural region. Some area indicators may identify minimum or maximum sizes or capabilities for the agricultural implements or attachments being utilized in the particular agricultural region. Such information may be automatically determined by an automated controller or may be received from a manager or operator via an operator interface. Such area indicators may provide assistance to a manager or automated control when assigning or delegating tasks to different equipment and personnel for different agricultural regions defined by different polygons.

In the example shown in FIG. 8D, controller 40 outputs control signals causing display 28 to display an example polygon 670 on map 632. As discussed above, the polygon 670 may serve as an area indicator providing one or more of the above characteristics for the geographical region enclosed by the polygon. In the example illustrated, the polygon interior is coded with a color corresponding to or associated with a particular characteristic of the geographical region. In other implementations, the polygon boundary may be coded with a color or other style designated for a particular characteristic. In other implementations, the interior of the polygon may be coded with a style, other than color, such as flashing, shading, line thickness, stippling or the like to indicate a particular characteristic associated with the geographical region contained within the polygon 670. In such implementations, an appropriate legend may be presented on display 28, wherein the legend identifies what particular styles correspond to what particular characteristics.

Selection of the snapshots map layer 652-2 makes snapshots available for viewing. For example, with the snapshots map layer 652-2 selected in the map layers icon 653 chosen, selection of a particular location on map 632 will cause controller 40 to retrieve and display the particular snapshots associated with the particular selected location. For example, in response to the particular geographic location at which icon 652-1-2 resides in FIG. 8E, controller 40 will present each of the snapshot 656 (even in circumstances where the particular selected location may not be associated with any particular icon, such as the guard rail icon 652-1-2.

In other implementations, operations playback system 620 may have additional or alternative map layers providing additional or alternative types or sets of operational data associated with particular times or geographic locations on map 632. In some implementations, system 620 may comprise less than each of the map layers and associated operational data types shown in the examples.

FIG. 9 illustrates an example vehicle 824 and implement/attachment 825 provided as part of an example operations playback system 820. FIG. 9 illustrates an example implementation of the vehicle 224 and implement/attachment 225 shown and described above with respect to FIG. 3. Vehicle 824 and implement/attachment 825 may be utilized as the vehicle 24 and implement/attachment in system 20 described above with respect to FIG. 4. In the example illustrated, vehicle 824 comprises a chassis 827 hooked up or carrying implement/attachment 825 and further supporting a releasable removable forward attachment 829 in the form of a bucket. In other implementations, the forward attachment 829 may comprise a fork or other tool. The implement/attachment 825 and the forward attachment 829 may be in one of various states, such as different heights, orientations and the like. The forward attachment 829 may be raised and lowered using hydraulics which raise and lower lift arms 830 to raise and lower forward attachment 829 and to control the tilt orientation of forward attachment 829. The implement/attachment 825 may be raised and lowered using hydraulics (a 3-point hitch) and may be powered via hydraulic lines, a power takeoff or the like. In some implementations, the forward attachment 829 and/or implement/attachment 825 may be omitted.

In the example illustrated, vehicle 824 further comprises a battery 831 which provides electrical power for driving a motor to propel vehicle 824. In some implementations, the electric motor may power a hydraulic pump which drive a hydraulic motor to further assist in propelling vehicle 824. Power from battery 831 may be utilized to also power the raising and lowering or tilting of forward attachment 829 and the powering of implement/attachment 825.

Vehicle 824 comprises various operations data acquisition devices in the form of cameras 800-1, 800-2, 800-3 (collectively referred to as cameras 300), GPS receiver 802, wheel odometry sensors 804, inertial measurement units 806, bucket sensors 808, implement/attachment sensors 810 and battery sensor 812. The signals output by such devices indicate, or may be used to derive, values for various operations data for vehicle 824 and/or implement/attachment 825.

Cameras 800 are located about chassis 827 of vehicle 824 and provide different viewpoints, capturing images or video of the front, rear and opposite sides of vehicle 224. Cameras 800 may comprise a monocular to the cameras or may comprise stereo or 3D cameras. Such cameras may capture images or video. Cameras 800 are supported by a roof 832 of the cab 834 of vehicle 824. In the example illustrated, camera 800-1 has a forward field-of-view. Camera 800-2 has a rearward field-of-view. Camera 800-3 has a leftward field-of-view. Vehicle 824 further comprises an additional camera (not shown) supported by roof 832 having a rightward field-of-view. In the example illustrated, images from cameras 800 may be utilized to derive the travel direction and speed of vehicle 824 for determining a location of vehicle 824. In some implementations, one or more of cameras 800 may be omitted.

GPS receiver 802 receives signals from a global positioning satellite system to triangulate the geographic coordinates or geographic location of vehicle 824 as vehicle 8224 traversing region 50 (shown in FIG. 1). Wheel odometry sensors 804 comprise one or sensors carried by vehicle 824 which are configured to output signals indicating the steered direction and speed or distance traveled by vehicle 824. Wheel odometry sensors 804 may comprise wheel encoders, steering angle potentiometers and the like. Signals from wheel odometry sensors 804 in conjunction with signals from GPS receiver 802 or in conjunction with a predetermined or known starting location of vehicle 824 may be utilized to determine particular locations of vehicle 824 as vehicle 824 is traversing region 50.

Inertial measurement units 806 comprise a combination of accelerometers and gyroscopes to determine the yaw, pitch and/or roll of vehicle 824. The pitch and roll of vehicle 824 may change as vehicle 824 is traversing different portions of region 50. Signals from inertial measurement unit 806 may be utilized by controller 40 to determine operations data values corresponding to the yaw, pitch and/or roll of vehicle 824 at different particular locations.

Bucket/fork/tool sensors 808 comprise sensors that output signals indicating the height and/or tilt/orientation of forward attachment 829. In the example illustrated, sensors 808 may comprise hydraulic pressure sensors, contact switches or other sensors configured to output signals indicating the extended length of the hydraulic cylinders that raise and lower or tilt attachment 829. The height and size or tilt/orientation of the forward attachment 829 may vary as vehicle 224 traverses region 50.

Implement/attachment sensors 810 comprises sensors that output signals indicating the current state of implement/attachment 825. Such sensors provide operational data values which are linked or associated with particular geographic coordinates, operational times, particular types of vehicles and particular operators for subsequent selection and operations playback. Sensors 810 may comprise material volume, level or amount sensors, such as sensors 810-1. Sensors 810-1 may comprise optical sensors in the form of photo-emitter detectors (for detecting a level or amount of material 852 (seed, herbicide, insecticide, fertilizer) in a bin or other volume 850. Sensors 810 may comprise weight or pressure sensors, such as sensors 810-2 configured to sense or downward pressure (weight) of material 852 contained in the storage container, bin or volume 850. Sensors 810 may comprise material distribution sensors, such as sensors 810-3 which output signals indicating the current distribution force, spread or pattern of material being distributed by a material distributor/applicator 856. In some implementations, sensors 810-3 comprise flow sensors that output signals indicating the current variable flow of material from volume 8502 the material distributor applicator 856 or the discharge of material from the material distributor 856. In some implementations, the material distributor/applicator 856 may be configured to distribute a liquid material, wherein the material is sprayed through a nozzle 858. In such implementations, sensor 810-3 may comprise a potentiometer or other sensor configured to output signals indicating the current state or opening of the nozzle. In some implementations, applicator 856 may be configured to distribute a dry or solid material, wherein the material is spread by rotating blades and wherein the spread or rate of application may depend upon the rotational velocity of the blades. In such implementations, sensors 810-3 may comprise a speed sensor to sense the rotational rate of the blades.

In some implementations, sensors 810 may comprise a plant interaction sensors 810-4 configured to sense the current state or positioning of plant interaction members 860. Plant interaction members 860 may interact with plans for operation such as pruning, cutting, harvesting or the like. For example, plant interaction memory 860 may comprise cutting blades of a mower. Sensors 810-4 may output signals indicating the current position (height or angle) of such members or the rate (rotational speed) at which such members are interacting with surrounding plants. Such sensors may comprise potentiometers, encoders, contact switches, hydraulic pressure sensor and the like configured to sense the positioning of arms or booms extending from attachment 825 or rate at which such members are being rotated or reciprocated.

In some implementations, sensors 810 may comprise ground interaction sensors 810-5 which output signals indicating the current state or positioning of ground interaction members 862 of implement/attachment 825. Such ground interaction members 862 may be in the form of wheels, cultivation blades in the form of discs or plow blades, and the like. Ground interaction sensors 810-5 may comprise potentiometers, encoders, contact switches, hydraulic pressure sensor, strain sensors, and the like configured to output signals indicating the current angle, extension or forces experienced by the ground interaction members of implement/attachment 825 as they interact with the underlying terrain or ground.

In some implementations, sensors 810 may comprise implement/attachment position sensors 810-6. Such sensors may be attached to the connection (three-point hitch) between the implement/attachment 825 and vehicle 824. Such sensors may output signals indicating the current height and/or orientation of the implement/attachment 825. For example, such sensors may comprise inertial measurement units compute output signals indicating the orientation of implement/attachment 825. Such sensors 810-6 may comprise hydraulic pressure sensor for detecting the extended length of a hydraulic cylinder-piston assembly which may correspond to the positioning, height or tilt of a component of the implement/attachment 825.

Battery sensor 812 comprises a sensor or multiple sensors configured to detect a status of battery 831. Battery sensor 212 may sense the current remaining charge level of battery 831. Battery sensor 812 may sense a current temperature of battery 831. Battery sensor 812 may sense the current voltage level or charging state of battery 831. Such operational data values may vary as vehicle 824 traverses region 50.

As shown by FIG. 9, the controller 40, operating interface 32 and display 28 forming the operations data recording and retrieval system used with vehicle 824 may either reside on vehicle 824 or may be remote from vehicle 824. When provided on vehicle 824, the operations data recording and retrieval system comprises display 28, operator interface 32 and controller 40 as described above. When provided remote from vehicle 824, the operations data recording and retrieval system comprises display 28′, operator interface 32′, and controller 40′. Controller 40′ may receive location signals and operations data signals from vehicle 224 (and implement/attachment 825) in a wireless fashion or in a wired fashion, such as when vehicle 824 is docked for charging battery 831.

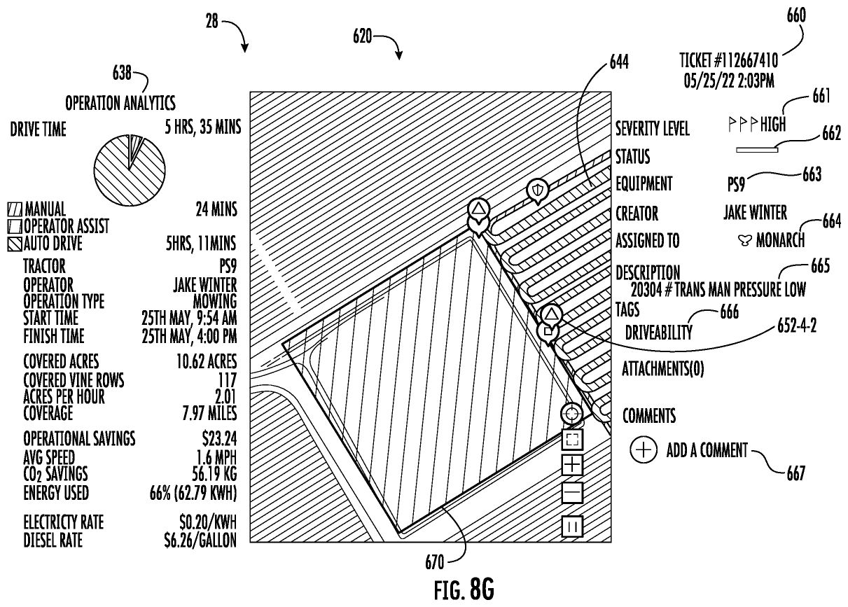

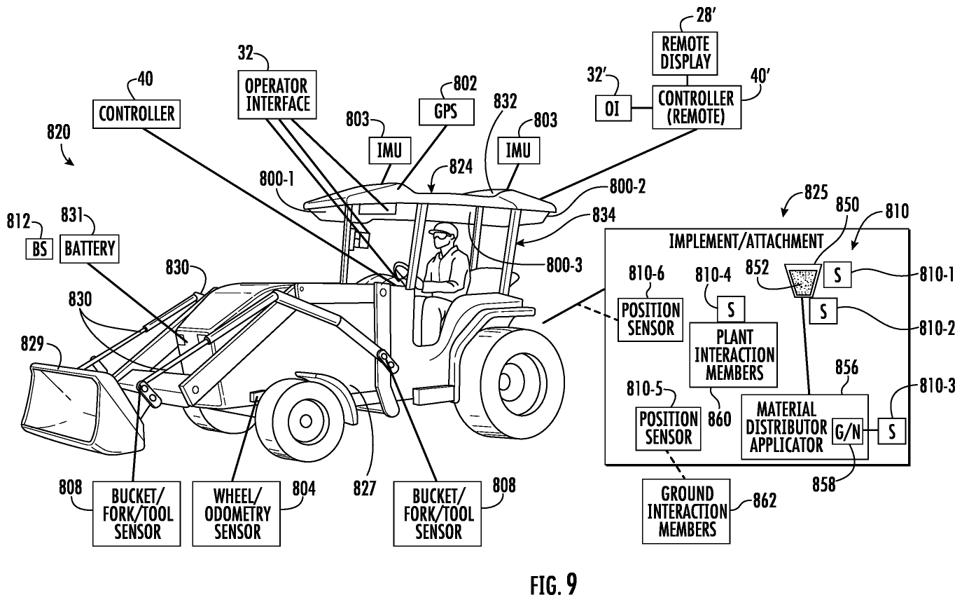

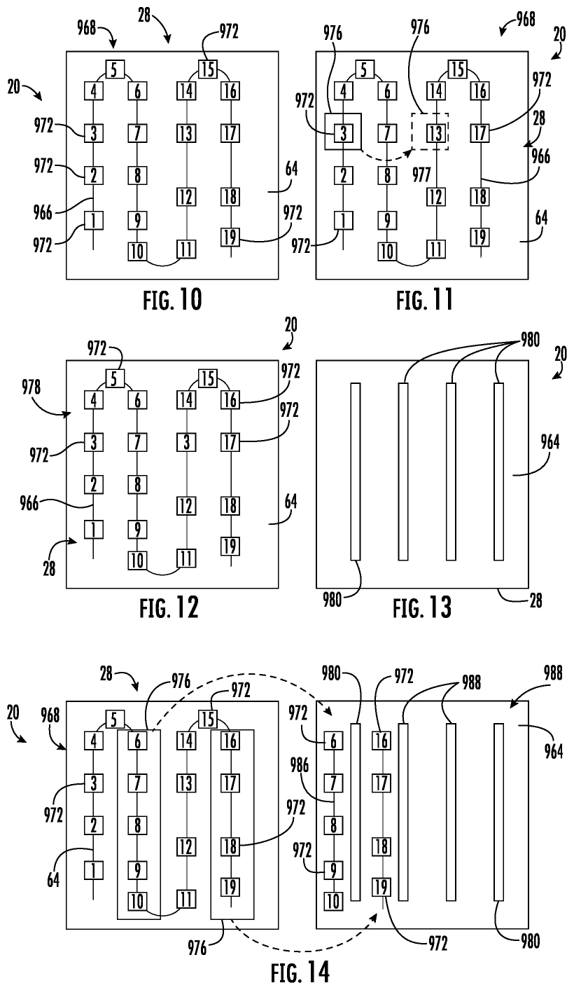

FIGS. 10-14 illustrate another example mode for system 20. FIG. 10-14 illustrate an example of how the stored operational data values and corresponding geographic coordinates and times may be used as a repeatable operations program or routine 968 for subsequent automated operation of a vehicle, such as vehicle 24, 324 or 824. In non-automated modes, the operations program or routines may be used by controller 40 as a basis for outputting recommended operator initiated operational settings or operational values for the vehicle at particular geographic locations or a particular times. FIGS. 10-14 further illustrate an example of how a stored operations routine may be modified or how a stored routine may be utilized to create a new routine for subsequent playback by a vehicle.

FIG. 10 is a diagram schematically illustrating a stored path 966 of a vehicle, the path comprising a series of stored geographic coordinates (obtained from a wheel odometry system and a starting geographic point or from a GPS system). FIG. 10 further illustrates an example portion of stored operational data values 972 (1-19) that have been sensed or retrieved and which are associated with corresponding geographic coordinates along the path 966. The stored geographic coordinates of the path and the stored associated operational data values form an operations program or routine that may be repeated. In one user selectable mode, system 20 facilitate subsequent use of the stored operation data values 972 and associated geographical coordinates along path 966 as a geography-based program or routine, wherein the same or similar operations data values are achieved by the vehicle and/or its implement when the vehicle and/or implement subsequently traverses the same geographical coordinates. Said another way, the vehicle and/or its implements may effectively playback the prior operations based upon the vehicle traveling to particular geographic coordinates.

For example, the recorded program or routine may comprise a first operations data value 972 (1) (such as a first vehicle speed) for a first geographic location or range of geographic coordinates, a second operations data value 972 (2) (such as a second different vehicle speed) for a second geographic location or range of geographic coordinates, a third operations data value 972 (3) (such as a third different vehicle speed) for a third geographic location or range of geographic, and so on. An operator may enter a command or instruction causing this routine to be conducted at any subsequent time, wherein the controller outputs control signals such that the vehicle 24, 324, 824 exhibits the same operation data values when the vehicle is at the same respective geographic coordinates or range of geographic coordinates. For example, during a subsequent pass of the vehicle through the region of the image or map, controller 40 may output control signals causing the vehicle to have the same prior recorded operation data values (speeds or other operational values) when the vehicle is once again at the associated geographic coordinates.

In some implementations, a series of stored operational data values and their respective times or durations are recorded, wherein the stored values and duration/times form a time-based operations routine or program based upon elapsed time since the beginning of the routine rather than geographic location and wherein controller 40 outputs control signals such that the time-based routine or program may be repeated at a later time. For example, the recorded operations program or routine may comprise a first operations data value (such as a first vehicle speed) for a first particular elapsed time or time range (a first historical timing value), a second operations data value (such as a second different vehicle speed) for a second elapsed time or time range (a second historical timing value) immediately following the first time or time range, a third operations data value (such as a third different vehicle speed) for a third time or time range (a third historical timing value) immediately following the second time range, and so on. An operator may enter a command or instruction causing this routine to be conducted at any subsequent time, wherein the controller outputs control signals such that the vehicle exhibits the same pattern of speeds and times. Said another way, when the vehicle has a current timing value (an elapsed time since the beginning of the routine, or since the last historical timing value) that corresponds to a particular historical timing value, the controller may output control signals causing the vehicle to exhibit the same operation data values corresponding to the matching particular historical timing value. In the above example, when the vehicle has a current timing value equaling the second elapsed time or time range (the second historical timing value), the controller may output control signals causing the vehicle to exhibit the second operations data value.

In one example mode for system 20, the stored values and travel distances form a travel distance operations routine or program based upon distance traveled by the vehicle rather than geographic location or elapsed time and wherein a controller outputs control signals such that the travel distance-based routine or program may be repeated at a later time. For example, the recorded program or routine may comprise a first operations data value (such as a first vehicle speed) for a first distance traveled by the vehicle (and implement) (a first historical travel distance) since the initiation of the routine, a second operations data value (such as a second different vehicle speed) for a second travel distance immediately following the first travel distance (a second historical travel distance), a third operations data value (such as a third difference vehicle speed) for a third travel distance immediately following the second travel distance (a third historical travel distance), and so on. An operator may enter a command or instruction causing this routine to be conducted at any subsequent time, wherein the controller outputs control signals such that the vehicle exhibits the same pattern of operation data values (speeds) and travel distances. After the vehicle has traveled the first travel distance, the controller outputs control signals causing the vehicle to achieve the second operations data value. After the vehicle has additionally traveled the second travel distance, following the first travel distance, the controller outputs control signals causing the vehicle to achieve the third operations data value, and so on. Said another way, when the vehicle has a current travel distance value (an elapsed travel distance since the beginning of the routine, or since the last historical travel distance value) that corresponds to a particular travel distance, the controller may output control signals causing the vehicle to exhibit the same operation data values corresponding to the matching particular historical travel distance. In the above example, when the vehicle has a current travel distance value equaling the second historical travel distance, the controller may output control signals causing the vehicle to exhibit the second operations data value.

In some implementations, system 20 further facilitates modifying the stored operations program or routine by selecting particular portions of a displayed map or image. FIG. 11 is a diagram illustrating the example stored operations routine 968 presented on display 28. FIG. 11 further illustrates a graphical user interface 976 presented on display 28 and in the form of a window. The window may be sized and located through manipulation of a mouse or other operator input device. As shown by FIG. 11, the graphical user interface 976 may be located to enclose or surround a particular portion or region of the map 64, to contain particular portions of path 966 and those operational data values 972 that occur along path 966. In response to the selection, controller 40 further presents on display 28 the operational data values associated with the region of the image or map 64 enclosed by the window of graphical user interface 976.

As indicated by arrow 977, an operator, using a mouse, touch screen or other input device, may relocate the window 976 to a different location along the path 966. As result, controller 40 copies the operational data values (3 in the example) to the new location along path 966, replacing the former operational data value (13). As shown by FIG. 12, this results in a new modified operations program or routine 978 with the new operational data value (3) associated with the geographic coordinates along path 966 previously associated with the operational data value (13).

This new operations routine 978 is stored and may be subsequently carried out by controller 40. In particular, as the vehicle 24, 324, 824 repeats path 966 in the particular field, orchard, vineyard or the like, controller 40 may output control signals causing the vehicle (and/or implement) to exhibit the same stored operational data values at the corresponding stored particular geographic locations. As described above, controller 40, in a user selected mode, may utilize the modified routing 978 as a time based routine or a travel distance based routine. Although FIGS. 11 and 12 illustrate such a modification involving a single operational data value (13) being replaced with the data value (3) along path 966, in other circumstances, the window forming graphical user interface 976 may encompass a larger region of path 966 which may result in the modification replacement of a larger number of operational data values in a previously stored operations routine to form a new operations routine.

FIGS. 13 and 14 illustrate an example of how an operations routine with associated operation data values and associated geographic locations (which are spaced by travel distances), and/or elapsed time values may be used to generate a new operations routine for the same geographic region of the prior routine or a different geographic region. As shown by FIG. 13, in a routine generation mode, controller 40 may present a map or image 964 of a geographic region on display 28. In some implementations, the image 964 may additionally include plant rows 980 at locations on the map or image 964 corresponding to particular geographic coordinates. The plant rows 980 may be determined from satellite imagery, determined from historical records established at time of planting, cultivation or earlier operations, determined from signals acquired by a vehicle (with a GPS system) traveling between such plant rows, or determined from signals acquired from a vehicle traveling around a perimeter of the field, orchard or vineyard and along a first row and with the input of the spacing between consecutive rows.

FIG. 14 illustrates an example where the prior recorded operations routine 968 is displayed alongside the map 964 depicting the same or a different geographic region including plant rows 980. The graphical user interface 976 may be used by an operator or manager to identify a selected portion of the routine 968 (on the left side of the display 28) and to transfer selected operational data values (and their spatial relationships) from routine 968 to the image 964 on the right side of display 28. The transfer of operational data values and their spatial relationships may be used to form a new path 986 along and between the crop rows 980 in the image 964. This process may continue until a new routine 988 is created for the region depicted in the map or image 964.

The operational data values (6-10) are assigned new geographic coordinates along and relative to the first row 980 of region 964 based upon the location in image 964 at which the operational data values are newly located while the operational data values (10-16) are assigned new geographic coordinates between and relative to the first and second rows 980 of region 964 based upon the location image 964 at which the operational data values are newly located. The spatial distancing between the operation data values from routine 968 is maintained in routine 988. As result, system 20 provides a user with the ability to intuitively create a new operations routine for a vehicle (or different vehicles) for the same geographic region or a completely different geographic region. For example, analytics may determine that a particular series of operational value adjustments along a path are best suited for a particular terrain type, soil type/condition, moisture condition (low lying wet spot) or the like. The series of operational value adjustments identified in a prior stored routine may be effectively copied a portions of a map or image of a different field, orchard, vineyard having similar characteristics to form a new routine for the different geographic region based upon the terrain type, soil type/condition, moisture condition or the like of the different geographic region (a different field, orchard or vineyard). Although FIG. 14 illustrates the prior routine 968 and the map or image 964 being presented on display 28 in a side-by-side fashion during the transfer, wherein the windows forming graphical user interfaces 976 are copied or dragged, in other implementations, routine 968 and the map or image 964 to which operational data values and spatial relationships are to be copied or transferred may be concurrently presented on display 28 in other fashions or may be sequentially presented on display 28. In some implementations, display 28 may comprise multiple side-by-side screens or monitors.

As shown by FIGS. 13-14, the controller may be configured to operate in a mode in which the controller: (1) records and stores operations data 972 during movement of the vehicle; (2) associates historical travel distances and/or historical timing values (the sum of the lengths of the segments spanning between operational data values 972) with different operations data values 972, each different historical travel distances and/or historical timing values having at least one associated operations data value 972; (3) outputs control signals causing the display to present a first image (left side of FIG. 14) depicting a region with a series of historical travel distance associated with operations data recorded and stored during movement of the vehicle in the region; (4) outputs control signals causing the display to present a second image depicting a second region (right side of FIG. 14); (5) receives a selection (via graphical user interface 976) of at least one historical travel distance and/or historical timing value from an operator on the first image 968 presented by the display 28; (6) receives a selection of a deposit location (shown at the end of the arrowheads on the right side of FIG. 14) for the at least one historical travel distance and/or historical timing value from an operator on the second image presented by the display; (7) outputs control signals causing the display to present the selection at the deposit location on the second image being presented by the display (depicted in the right side of FIG. 14); and (8) subsequently outputs control signals causing the vehicle to achieve particular operations data values associated with the at least one historical travel distance and/or historical timing value in response to a determination that the vehicle, when traveling in the second region, has the at least one current travel distance and/or current timing value corresponding to the at least one historical travel distance and/or historical timing value. In the example illustrated, FIG. 14 illustrates the selection of multiple historical travel distances and/or historical timing values (associated with operation data values 6, 7, 8, 9 and 10) and their transfer to the region depicted on the right side of FIG. 14. After their transfer, the relative timing or distant spacing of the different operation data values 6-10 in the second region is preserved. Such the same portion of the overall routine shown in the left side of FIG. 14 may be repeated in the region depicted on the right side of FIG. 14. Said another way, the controller is able to copy routine sub portions from one region to another region such that the same routine sub portion may be carried out in multiple different geographic regions or may be automatically repeated by an automated vehicle in the same geographic region at a different time, such as during a different crop season.

Although the claims of the present disclosure are generally directed to displaying operations data values that are based upon a particular operations data values associated with particular selected locations, the present disclosure is additionally directed to the features set forth in the following definitions.
Definition 1. An operations playback system comprising:
   a vehicle;
   a display;
   an operator interface comprising a graphical user interface;
   a controller configured to:
      record and store operations data during movement of the vehicle;
      associate different locations with different operations data values;
      output control signals causing the display to present an image of a region traversed by the vehicle;
      receive a selection of a portion of the image being presented from the graphical user interface;
      determine a particular location based on the selection of the portion of the image;
      output control signals causing the display to present a displayed operations data value that is based upon a particular operations data value associated with the particular location.
Definition 2. The operations playback system of definition 1 further comprising a global positioning satellite (GPS) system carried by the vehicle, wherein the controller is configured to determine the different locations based upon signals from the GPS system.
Definition 3. The operations playback system of definition 1 further comprising an odometry system carried by the vehicle, wherein the controller is configured to determine the different locations based upon a map, an initial starting point of the vehicle, and signals from the odometry system.
Definition 4. The operations playback system of any of definitions 1-3, wherein the portion of the image consists of a single particular location and wherein the displayed operations data value comprises the particular operations data value associated with the particular location.
Definition 5. The operations playback system of any of definitions 1-3, wherein the portion of the image encompasses a plurality of particular locations and wherein the displayed operations data value is based upon a combination of a plurality of operations data values respectively associated with the plurality of particular locations.
Definition 6. The operations playback system of any of definitions 1-5, wherein the controller is configured to associate different operations data values with different pixels of the image, the graphical user interface is configured to select at least one pixel of the image and wherein the displayed operations data value is based upon the at least one pixel of the image and selected by the graphical user interface.
Definition 7. The operations playback system of any of definitions 1-6, wherein the controller is configured to associate the different locations and the operations data values associated with a different locations with different operational times.
Definition 8. The operations playback system of definition 7 wherein the operator interface is configured to receive a selected operational time, wherein the controller is configured to output control signals causing the display to present a location of the vehicle in the image at the selected operational time and to present a displayed operations data value associated with the location.
Definition 9. The operations playback system of definition 8, wherein the controller is configured to:
   receive an operations data value via the operator interface; and
   output control signals causing the display to present a location of the vehicle in the image associated with the operations data value received via the operator interface.
Definition 10. The operations playback system of definition 9, the controller is further configured to output control signals causing a display to present a time associated with the location of the vehicle associated with the operations data value received via the operator interface.
Definition 11. The operations playback system of definition 9, wherein the controller is configured to output control signals causing a display to present a plurality of locations of the vehicle in the image, each of which is associated with the operations data value received via the operator interface.
Definition 12. The operations playback system of any of definitions 1-6, wherein the controller is configured to:
   receive and operations data value via the operator interface; and
   output control signals causing the display to present at least one location of the vehicle in the image, each of the at least one location of the vehicle in the image being associated with the operations data value received via the operator interface.
Definition 13. The operations playback system of any of definitions 1-6, wherein the controller is configured to:
   receive a plurality of operations data values via the operator interface; and
   output control signals causing the display to present at least one location of the vehicle in the image, each of the at least one location of the vehicle in the image being associated with each of the plurality of the operations data values received via the operator interface.
Definition 14. The operations playback system of any of definitions 1-13, wherein the operations data is selected from a group of operational data consisting of: vehicle speed; vehicle mode (manual/autonomy), vehicle health, human detection, path obstructions, snapshots, videos, ticket creation, remaining battery charge, battery voltage, battery temperature, vehicle RPM, implement height, implement status, bucket height, bucket orientation, bucket load, wheel slip, vehicle path, vehicle pitch, and vehicle roll.
Definition 15. The operations playback system of any of definitions 1-14, wherein the controller is configured to record and store the operations data at one of a plurality of operator selectable frequencies.
Definition 16. The operations playback system of definition 1, wherein the controller is configured to record and store the operations data at a frequency based upon a speed at which the vehicle is traveling.
Definition 17. The operations playback system of any of definitions 1-16, wherein the controller is configured to overlay a yield map image over the image.
Definition 18. The operations playback system of any of definitions 1-17, wherein the controller is configured to overlay a disease/infestation map over the image.
Definition 19. The operations playback system of any of definitions 1-18, wherein the controller is configured to overlay a soil type map over the image.
Definition 20. The operations playback system of any of definitions 1-19, the controller is configured to overlay a soil moisture map over the image.
Definition 21. An operations playback system comprising:
   a vehicle;
   a display;
   an operator interface;
   a controller configured to:
      record and store operations data during movement of the vehicle;
      associate different locations with different operations data values;
      output control signals causing the display to present an image of a region traversed by the vehicle;
      receive an operations data value from the operator interface;
      determine a particular location of the vehicle in the image based on the operations data value received from the operator interface; and
      output control signals causing the display to present the particular location on the image.
Definition 22. An operations playback system comprising:
   a vehicle;
   a display;
   an operator interface;
   a controller configured to:
      record and store operations data during movement of the vehicle;
      associate different locations with different operations data values;
      associate different times with the different locations;
      output control signals causing the display to present an image of a region traversed by the vehicle;
      receive a time value from the operator interface;
      determine a particular location of the vehicle in the image based on the time value received from the operator interface; and
      output control signals causing the display to present the particular location on the image and a particular operations data value associated with the particular location.
Definition 23. The operations playback system of definition 22, wherein the time value is a chronological time.
Definition 24. The operations playback system of definition 22, wherein the time value is an amount of time.
Definition 25. An operations data recording and retrieval system comprising:
   a non-transitory computer-readable medium containing instructions configured to direct the processor to:
      record and store operations data during movement of a vehicle;
      associate different locations with different operations data values;
      output control signals causing a display to present an image of a region traversed by the vehicle;
      receive a selection of a portion of the image being presented from a graphical user interface;
      determine a particular location based on the selection of the portion of the image;
      output control signals causing the display to present a displayed operations data value that is based upon a particular operations data value associated with the particular location.
Definition 26. An operations data recording and retrieval system comprising:
   a non-transitory computer-readable medium containing instructions configured to direct the processor to:
      record and store operations data during movement of a vehicle;
         associate different locations with different operations data values;
         output control signals causing a display to present an image of a region traversed by the vehicle;
         receive an operations data value from an operator interface;
         determine a particular location of the vehicle in the image based on the operations data value received from the operator interface; and
         output control signals causing the display to present the particular location on the image.
Definition 27. An operations data recording and retrieval system comprising:
   a non-transitory computer-readable medium containing instructions configured to direct the processor to:
      record and store operations data during movement of a vehicle;
         associate different locations with different operations data values;
         associate different times with the different locations;
         output control signals causing a display to present an image of a region traversed by the vehicle;
         receive a time value from an operator interface;
         determine a particular location of the vehicle in the image based on the time value received from the operator interface; and
         output control signals causing the display to present the particular location on the image and a particular operations data value associated with the particular location.
Definition 28. An operations playback system comprising:
   a vehicle;
   a controller configured to:
      record and store operations data during movement of the vehicle;
      associate different locations with different operations data values, each different location having at least one associated operations data value;
   determine when the vehicle has returned to a particular location; and
      output control signals causing the vehicle to achieve a particular operations data value associated with the particular location when the vehicle is at the particular location.
Definition 29. The operations playback system of Definition 28 further comprising:
   a display;
   an operator interface comprising a graphical user interface,
   wherein the controller is configured to:
      output control signals causing the display to present an image of a region traversed by the vehicle;
         receive a selection of a portion of the image being presented from the graphical user interface;
         determine a particular location based on the selection of the portion of the image; and
         output control signals causing the display to present a displayed operations data value that is based upon the particular location.
Definition 30. The operations playback system of Definition 29, wherein the controller is configured to:
receive and store a modification for at least one operations data value associated with the particular location; and
output control signals causing the vehicle to operate so as to achieve the modified operations data value when the vehicle is subsequently at the particular location.
Definition 31. The operations playback system of Definition 30, wherein the controller is configured to:
receive a second selection of a second portion of the image being presented from the graphical user interface;
record a new operations data value for a third portion of the image based upon the second selection of the second portion of the image; and
output control signals causing the vehicle to operate so as to achieve the new operations data value when the vehicle is subsequently at a location corresponding to the third portion of the image.
Definition 32. An operations playback system comprising:
   a vehicle;
   a controller configured to:
      record and store operations data during movement of the vehicle;
      associate historical timing values with different operations data values, each different historical timing value having at least one associated operations data value; and
      output control signals causing the vehicle to achieve a particular operations data value associated with a particular historical timing value in response to a determination that the vehicle having a current timing value corresponding to the particular historical timing value.
Definition 33. An operations playback system comprising:
   a vehicle;
   a controller configured to:
      record and store operations data during movement of the vehicle;
      associate historical travel distances with different operations data values, each different historical travel distances having at least one associated operations data value; and
      output control signals causing the vehicle to achieve a particular operations data value associated with a particular historical travel distance in response to a determination that the vehicle having a current travel distance value corresponding to the particular historical travel distance.
Definition 34. An operations playback system comprising:
a vehicle;
a display;
a controller configured to:
   record and store operations data during movement of the vehicle;
   associate historical travel distances and/or historical timing values with different operations data values, each different historical travel distances and/or historical timing values having at least one associated operations data value;
output control signals causing the display to present a first image depicting a region with a series of historical travel distance associated with operations data recorded and stored during movement of the vehicle in the region;
output control signals causing the display to present a second image depicting a second region;
receiving a selection of at least one historical travel distance and/or historical timing value from an operator on the first image presented by the display;
receiving a selection of a deposit location for the at least one historical travel distance and/or historical timing value from an operator on the second image presented by the display;
output control signals causing the display to present the selection at the deposit location on the second image being presented by the display;
   output control signals causing the vehicle to achieve particular operations data values associated with the at least one historical travel distance and/or historical timing value in response to a determination that the vehicle, when traveling in the second region, has the at least one current travel distance and/or current timing value corresponding to the at least one historical travel distance and/or historical timing value.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. An operations playback system comprising:
a vehicle;
a display;
an operator interface comprising a graphical user interface; and
a controller configured to:
record and store operations data during movement of the vehicle;
associate different locations with different operations data values;
output control signals causing the display to present an image of a region traversed by the vehicle;
receive a selection of a portion of the image being presented from the graphical user interface;
determine a particular location based on the selection of the portion of the image; and
output control signals causing the display to present a displayed operations data value that is based upon a particular operations data value associated with the particular location.

2. The operations playback system of claim 1 further comprising a global positioning satellite (GPS) system carried by the vehicle, wherein the controller is configured to determine the different locations based upon signals from the GPS system.

3. The operations playback system of claim 1 further comprising an odometry system carried by the vehicle, wherein the controller is configured to determine the different locations based upon a map, an initial starting point of the vehicle, and signals from the odometry system.

4. The operations playback system of claim 1, wherein the portion of the image consists of a single particular location and wherein the displayed operations data value comprises the particular operations data value associated with the particular location.

5. The operations playback system of claim 1, wherein the portion of the image encompasses a plurality of particular locations and wherein the displayed operations data value is based upon a combination of a plurality of operations data values respectively associated with the plurality of particular locations.

6. The operations playback system of claim 1, wherein the controller is configured to associate different operations data values with different pixels of the image, the graphical user interface is configured to select at least one pixel of the image and wherein the displayed operations data value is based upon the at least one pixel of the image and selected by the graphical user interface.

7. The operations playback system of claim 1, wherein the controller is configured to associate the different locations and the operations data values associated with a different locations with different operational times.

8. The operations playback system of claim 1, wherein the controller is configured to associate the different locations and the operations data values associated with a different locations with different operational times, wherein the operator interface is configured to receive a selected operational time, wherein the controller is configured to output control signals causing the display to present a location of the vehicle in the image at the selected operational time and to present a displayed operations data value associated with the location.

9. The operations playback system of claim 8, wherein the controller is configured to:
receive an operations data value via the operator interface; and
output control signals causing the display to present a location of the vehicle in the image associated with the operations data value received via the operator interface.

10. The operations playback system of claim 9, the controller is further configured to output control signals causing a display to present a time associated with the location of the vehicle associated with the operations data value received via the operator interface.

11. The operations playback system of claim 9, wherein the controller is configured to output control signals causing a display to present a plurality of locations of the vehicle in the image, each of which is associated with the operations data value received via the operator interface.

12. The operations playback system of claim 1, wherein the controller is configured to:
receive an operations data value via the operator interface; and
output control signals causing the display to present at least one location of the vehicle in the image, each of the at least one location of the vehicle in the image being associated with the operations data value received via the operator interface.

13. The operations playback system of claim 1, wherein the controller is configured to:
receive a plurality of operations data values via the operator interface; and
output control signals causing the display to present at least one location of the vehicle in the image, each of the at least one location of the vehicle in the image being associated with each of the plurality of the operations data values received via the operator interface.

14. The operations playback system of claim 1, wherein the operations data is selected from a group of operational data consisting of:
vehicle speed; vehicle mode (manual/autonomy), vehicle health, human detection, path obstructions, snapshots, videos, ticket creation, remaining battery charge, battery voltage, battery temperature, vehicle revolutions per minute (RPM), implement height, implement status, bucket height, bucket orientation, bucket load, wheel slip, vehicle path, vehicle pitch; and vehicle roll.

15. The operations playback system of claim 1, wherein the controller is configured to record and store the operations data at one of a plurality of operator selectable frequencies.

16. The operations playback system of claim 1, wherein the controller is further configured to overlay a map, the map selected from a group of maps consisting of: a yield map; a disease/infestation map; a soil type map; and a soil moisture map.

17. The operations playback system of claim 1, wherein the controller is further configured to:
determine when the vehicle has returned to a particular location; and
output control signals causing the vehicle to achieve a particular operations data value associated with the particular location when the vehicle is at the particular location.

18. The operations playback system of claim 1, wherein the controller is further configured to:
receive and store a modification for at least one operations data value associated with the particular location; and
output control signals causing the vehicle to operate so as to achieve the modified operations data value when the vehicle is subsequently at the particular location.

19. The operations playback system of claim 1, wherein the controller is configured to:
receive a second selection of a second portion of the image being presented from the graphical user interface;
record a new operations data value for a third portion of the image based upon the second selection of the second portion of the image; and
output control signals causing the vehicle to operate so as to achieve the new operations data value when the vehicle is subsequently at a location corresponding to the third portion of the image.

20. The operations playback system of claim 1, wherein the controller is further configured to:
associate historical travel distances and/or historical timing values with different operations data values, each different historical travel distances and/or historical timing values having at least one associated operations data value;
output control signals causing the display to present a first image depicting a region with a series of historical travel distance associated with operations data recorded and stored during movement of the vehicle in the region;
output control signals causing the display to present a second image depicting a second region;
receive a selection of at least one historical travel distance and/or historical timing value from an operator on the first image presented by the display;
receive a selection of a deposit location for the at least one historical travel distance and/or historical timing value from an operator on the second image presented by the display;
output control signals causing the display to present the selection at the deposit location on the second image being presented by the display; and
output control signals causing the vehicle to achieve particular operations data values associated with the at least one historical travel distance and/or historical timing value in response to a determination that the vehicle, when traveling in the second region, has the at least one current travel distance and/or current timing value corresponding to the at least one historical travel distance and/or historical timing value.
